(19) United States
(12) Patent Application Publication
(10) Pub. No.: US 2026/0262804 A1
(43) Pub. Date: Sep. 10, 2026

(54) COMPOSITE STRINGER, METHOD FOR MANUFACTURING SAME, AND METHOD FOR MANUFACTURING TAPE PART OF COMPOSITE STRINGER

(71) Applicant: YKK CORPORATION, Chiyoda-ku, Tokyo (JP)

(72) Inventors: Zhiyu REN, Toyama (JP); Atsushi NAKAYA, Toyama (JP)

(21) Appl. No.: 18/728,858

(22) PCT Filed: Mar. 2, 2023
(86) PCT No.: PCT/JP2023/007880

§ 371 Date: May 15, 2026

(30) Foreign Application Priority Data
Mar. 3, 2022 (WO) PCT/JP2022/009224

(51) Int. Cl. A44B 19/32; A44B 19/34; A44B 19/40

(52) U.S. Cl. CPC A44B 19/32; A44B 19/343; A44B 19/406

(57) ABSTRACT

Fastening device includes a pair of composite stringers and a slider. Tape portion of each composite stringer includes at least one sheet member, and a resin that adheres to the at least one sheet member and is formed as a layer extending along the at least one sheet member. The at least one sheet member has a resin-permeable structure. The resin permeates the structure of said at least one sheet member. The tape portion has surface conditions in accordance with the structure of the at least one sheet member in both of the first and second tape faces based on the permeation of the resin into the structure of the at least one sheet member

### TECHNICAL FIELD

The present disclosure is related to a composite stringer and a method of producing the same, and a method of producing a tape portion of a composite stringer.

### BACKGROUND ART

Slide fastener has been used for various waterproof articles such as clothes, bags, shoes, suitcases and the others. For a purpose of imparting watertightness to these articles, it has been conducted to stack a waterproof film such as polyurethane film onto a water-permeable fastener tape to obtain an instantaneous waterproofness.

In connection to the above point, Patent literature 1 discloses a technique where a film member is stacked onto a tape main portion via a reactive hot-melt adhesive. Patent literature 2 discloses that water-sealing layer such as a polyurethane film or the like is adhered to or melted and attached to a surface of a fastener chain (See paras. 0025 and 0034 of the same document). Patent literature 3 discloses that a synthetic resin film made of lamination of a resin layer with a lower melting point and a resin layer with a higher melting point is stacked onto a fastener tape, and the resin layer with a lower melting point is melted and attached to the fastener tape. Patent literature 4 discloses that a low temperature molten layer permeates a tape (See FIG. 5 and para.0039 of the same literature). It should be noted that the patent literatures 5-8 are related to hook-and-loop fasteners or other types of devices.

### Citation List

### Patent literature

[PTL 1] International Publication No. 2021/048936
[PTL 2] Japanese U.S. Pat. No. 4,689,631
[PTL 3] Japanese Patent No.3,580,725
[PTL 4] Japanese Patent No.5,908,938
[PTL 5] International Publication No. 2020/166069
[PTL 6] Japanese Patent No.3,673,811
[PTL 7] Japanese Patent Application Laid-open No. 9-501590
[PTL 8] International Publication No. 2019/039388

### SUMMARY

### Technical Problem

When a waterproof film such as polyurethane film is stacked onto a fastener tape, one face of the fastener tape is covered by the waterproof film and a texture thereof is lost. Slide fastener with higher waterproofness has been developed for marine sport, but its production cost is first of all quite expensive due to its configuration and additionally, it involves a similar technical issue as noted above as it uses a fastener tape in which a tape base member is covered by a resin layer.

In view of the above-described non-limitting exemplary problem, the present inventors have newly identified a technical challenge to easily improve surface conditions in both faces of a tape portion of waterproof fastening device. [Solution to Problem] Fastening device according to an aspect of the present disclosure includes a pair of composite stringers; and a slider. Each composite stringer of the pair of composite stringers includes a fastening portion and a tape portion that is wider than the fastening portion and has a thickness defined by first and second tape faces. The tape portion includes at least one sheet member and a resin that adheres to the at least one sheet member and is formed as a layer along said at least one sheet member. The at least one sheet member has a resin-permeable structure. The resin permeates the structure of the at least one sheet member. The tape portion has surface conditions in accordance with the structure of the at least one sheet member in both of the first and second tape faces based on the permeation of the resin into the structure of the at least one sheet member. The structure of the at least one sheet member may be observable in both of the first and second tape faces.

In some embodiments, the at least one sheet member includes first and second sheet portions each having resin-permeable structure, and the first and second sheet portions overlap via the resin. The resin permeates the respective structures of the first and second sheet portions to allow the tape portion to have a surface condition of the first tape face in accordance with the structure of the first sheet portion and to have a surface condition of the second tape face in accordance with the structure of the second sheet. Commercially available inexpensive thin sheet member may be employed to improve both of the tape faces. The first and second sheet portions may be different portions of a same sheet member or belongs to separate sheet members. Regarding the latter case, the first and second sheet portions may be read as first and second sheet members.

In some embodiments, the first tape face is a hybrid surface of a resin surface of the resin and an exposed portion of the first sheet portion, the first sheet portion being partially covered by the resin, and the second tape face is a hybrid surface of a resin surface of the resin and an exposed portion of the second sheet, the second sheet portion being partially covered by the resin. In other words, the first sheet portion emerges at least partially from the resin surface in the first tape surface, and the second sheet portion emerges at least partially from the resin surface in the second tape surface. The surface condition of the tape portion in at least one of the first and second tape faces may impart a tactile sense of fibers.

In some embodiments, the first sheet portion may be a woven or knitted fabric. Typically, the first sheet portion is a knitted fabric including a plurality of first knitting yarns, and the first tape face includes exposed portions of the first knitting yarns exposed in the first tape face and resin surfaces of the resin each formed between the exposed portions. This point equally applies to the second sheet. In particular, the second sheet portion is typically a knitted fabric including a plurality of second knitting yarns, and the second tape face includes exposed portions of the second knitting yarns exposed in the second tape face and resin surfaces of the resin each formed between the exposed portions.

In some embodiments, the first sheet portion is a knitted fabric including plural first chain stitch yarns forming plural wales and one or more first weft inserted yarns that swing in a width of two or more adjacent wales of the plural wales, and each first chain stitch yarn of the plural first chain stitch yarns has a series of pairs of first raised portions which are raised from a resin surface of the resin permeating the structure of the first sheet portion. The pair of the first raised portions may be formed by two thread portions that extend in a wale direction in one needle loop of the first chain stitch yarn. The first tape face includes the resin surface of the resin interposed between the two thread portions which are adjacent in a course direction. The one or more first weft inserted yarns may be partially exposed and are partially covered by the resin in the first tape face. The first tape face may include the resin surface of the resin interposed between portions of the first weft inserted yarns extending in a course direction.

In some embodiments, the second sheet portion is a knitted fabric including plural second chain stitch yarns forming plural wales and one or more second weft inserted yarns that swing in a width of two or more adjacent wales of the plural wales, and each second chain stitch yarn of the plural second chain stitch yarns has a series of pairs of second raised portions which are raised from the resin surface of the resin permeating the structure of the second sheet.

Fastening device according to another aspect of the present disclosure includes a pair of composite stringers; and a slider. Each composite stringer of the pair of composite stringers includes a fastening portion and a tape portion that is wider than the fastening portion and has a thickness defined by first and second tape faces. The tape portion includes first and second sheet portions each having a resin-permeable structure, and a resin via which the first and second sheet portions overlap. The resin permeates the respective structures of the first and second sheet portions to allow the tape portion to have a surface condition of the first tape face in accordance with the structure of the first sheet portion and to have a surface condition of the second tape face in accordance with the structure of the second sheet. The above noted every feature is also applicable to this fastening device individually or in any combination.

With respect to the fastening portion, embodiments below are envisaged. In one case, the fastening portion includes: a groove that extends along an elongation direction so as to form a box portion at a side of the second tape face of the tape portion; and an array of fastening elements in which the fastening elements are arranged on a bottom surface of the groove along the elongation direction and gaps are formed between adjacent fastening elements. In another case, the fastening portion includes a fastener element, and a supporting portion that is separate to the fastener element and supports the fastener element. The supporting portion is coupled to the tape portion in a same layer at least partially, the supporting portion including an extended portion of the at least one sheet member from the tape portion into the fastening portion and an extended portion of the resin from the tape portion into the fastening portion. Other configurations of the fastening portion may be employed.

The supporting portion includes a first portion and a second portion which are coupled via a bent portion, the first portion coupled to the tape portion in a same layer, the supporting portion is bent at the bent portion such that the first portion and the second portion overlap, and the fastener element is secured to the second portion. The bent portion may be provided with a notch on its inner side which is formed continuously or intermittently along the elongation direction of the composite stringer.

A method of producing at least a tape portion of a composite stringer according to yet another aspect of the present disclosure includes: supplying a soft or molten resin onto a circumferential surface of a roll; and supplying at least one sheet member having a resin-permeable structure onto the circumferential surface of the roll simultaneously as the supplying of the resin onto the circumferential surface of the roll. The resin permeates the structure of the at least one sheet member, allowing the tape portion to have surface conditions in accordance with the structure of the at least one sheet member in both of first and second tape faces which define a thickness of the tape portion.

In some embodiments, first and second sheet portions each having a resin-permeable structure are supplied as the at least one sheet member. The resin is supplied into a space between a pair of rolls that includes the roll as a first roll; the first and second sheet portions are fed into the space between the pair of rolls so as to interpose the resin; and the resin permeates the respective structures of the first and second sheet portions to allow the tape portion to have a surface condition of the first tape face in accordance with the structure of the first sheet portion and to have a surface condition of the second tape face in accordance with the structure of the second sheet.

A method of producing a composite stringer according to yet another aspect of the present disclosure includes forming the tape portion in accordance with any one of the above-described methods; and forming a fastening portion of the composite stringer together with the forming the tape portion. The circumferential surface of the roll includes first and second molding belts that are adjacent in a width direction of the roll and extend in a circumferential direction of the roll. The first molding belt is adapted for molding the fastening portion including at least plural fastening elements, and the second molding belt is adapted for molding or forming the tape portion.

A method of producing a composite stringer according to yet another aspect of the present disclosure includes: producing a fastener tape in a way to include any one of the above-described methods; and attaching a fastener element to a side-edge portion of the fastener tape.

A composite stringer according to yet another aspect of the present disclosure includes a waterproof fastener tape having a thickness defined by first and second tape faces; and a fastener element attached to a side-edge portion of the fastener tape. The fastener tape includes first and second sheet portions each having a resin-permeable structure, and a resin via which the first and second sheet portions overlap. The resin permeates the respective structures of the first and second sheet portions to allow the fastener tape to have a surface condition of the first tape face in accordance with the structure of the first sheet portion and to have a surface condition of the second tape face in accordance with the structure of the second sheet. The above noted every feature is also applicable to this composite stringer individually or in any combination.

### Advantageous Effects of Invention

According to an aspect of the present disclosure, surface conditions in both faces of tape portion is easily improved based on use of sheet member.

### BRIEF DESCRIPTION OF DRAWINGS

FIG. 1 is a schematic perspective view of a pair of composite stringers in decoupled state according to an aspect of the present disclosure, depicting first face of one composite stringer and second face of the other composite stringer.

FIG. 2 is a schematic perspective view of a pair of composite stringer in coupled state.

FIG. 3 is a schematic view of a composite stringer in cross section taken along a width direction thereof.

FIG. 4 is a schematic view of a composite stringer in cross section taken along an elongation direction thereof.

FIG. 5 is a schematic view depicting an engaged state of respective fastening portions (fastening elements) in a pair of composite stringers, and also depicting a slider used for engaging and disengaging the fastening portions.

FIG. 6 is a schematic perspective view depicting an apparatus for production of composite stringer.

FIG. 7 is a schematic side view depicting an apparatus for production of composite stringer.

FIG. 8 is an elevation view of a primary molded part produced by the production apparatus.

FIG. 9 is a schematic view of the primary molded part in cross section taken along its width direction.

FIG. 10 is a schematic cross-sectional view depicting arrangement of circumferential surfaces of first and second die wheels.

FIG. 11 is another schematic cross-sectional view depicting arrangement of circumferential surfaces of first and second die wheels.

FIG. 12 is a schematic view depicting arrangement of circumferential surfaces of first and second die wheels in cross section taken along a circumferential direction.

FIG. 13 is a schematic partial elevation view of a second face of a primary molded part.

FIG. 14 is a schematic process diagram illustrating a process of dividing the primary molded part.

FIG. 15 is a schematic process diagram illustrating that a pair of composite stringers is produced by dividing the primary molded part produced.

FIG. 16 is a schematic view depicting a variation of apparatus for producing a composite stringer.

FIG. 17 is a schematic view depicting a variation of apparatus for producing a composite stringer.

FIG. 18 is a schematic view depicting a variation of apparatus for producing a composite stringer.

FIG. 19 is a schematic view depicting a variation of cross-sectional configuration of a composite stringer.

FIG. 20 is a photograph of first face of composite stringer according to working example.

FIG. 21 is a photograph of second face of composite stringer according to working example.

FIG. 22 is a photograph of a fastening device including an assembled pair of composite stringers according to working example.

FIG. 23 is a schematic view depicting a primary molded part 8 according to another example produced by a method that follows a method shown in FIG. 17.

FIG. 24 is an elevation view of a fastening device (slide fastener) according to another aspect of the present disclosure.

FIG. 25 is a partial schematic view of a fastening device (slide fastener).

FIG. 26 is a partial schematic view of knitted structure of sheet member.

FIG. 27 is a partial schematic view depicting a tape portion in cross section taken along alternate long and short dash line in FIG. 26.

FIG. 28 is a partial schematic view of woven structure of sheet member.

FIG. 29 is a schematic view depicting a surface condition of first tape face of tape portion according to working example, the view obtained through image processing from a photograph of the surface condition of the first tape face.

FIG. 30 is a photograph of tape portion in cross section according to working example.

FIG. 31 is an elevation view of fastening device (conceal slide fastener) according to another aspect of the present disclosure.

FIG. 32 is a partial schematic view depicting a schematic cross-section corresponding to alternate long and short dash line in FIG. 31.

FIG. 33 is a schematic view depicting another example in which fastener elements are separate individual resin-made elements.

FIG. 34 (a) depicts a shape of aperture of extruder die and a resin material extruded there-through, and FIG. 34(b) depicts a fastener tape produced by feeding a sheet member to enclose the resin material so that both are integrated.

FIG. 35 depicts an embodiment where a core thread is enclosed in a core portion at a side edge of fastener tape.

FIG. 36 depicts a composite stringer in which resin-made elements are attached through injection molding to a core portion at a side edge of fastener tape.

### DESCRIPTION OF EMBODIMENTS

Hereinafter, various embodiments and features would be discussed with reference to drawings. A skilled person would be able to combine respective embodiments and/or respective features without requiring excess description, and would appreciate synergistic effects of such combinations. Overlapping description among the embodiments are basically omitted. Referenced drawings aim mainly for describing inventions and are simplified for the sake of convenience of drawing preparation. The respective features should be appreciated as universal features not only effective to composite stringers and methods of producing the same presently disclosed but also effective to other various composite stringers and methods of producing the same not disclosed in the present specification.

In the present specification, directions may be defined based on a central line AX (See FIG. 2) of fastening device 100. For clearer description, we define a direction on or in parallel to the central line AX as front-rear direction; a direction orthogonal to the central line AX and parallel to a width direction of fastening device 100 as left-right direction; and a direction orthogonal to the above-defined directions as up-down direction. Directions may be referred which are differently defined from the above ones. For example, the front-rear direction and elongation direction may be replaceable. The left-right direction and the width direction may be replaceable. The up-down direction and the thickness direction may be replaceable.

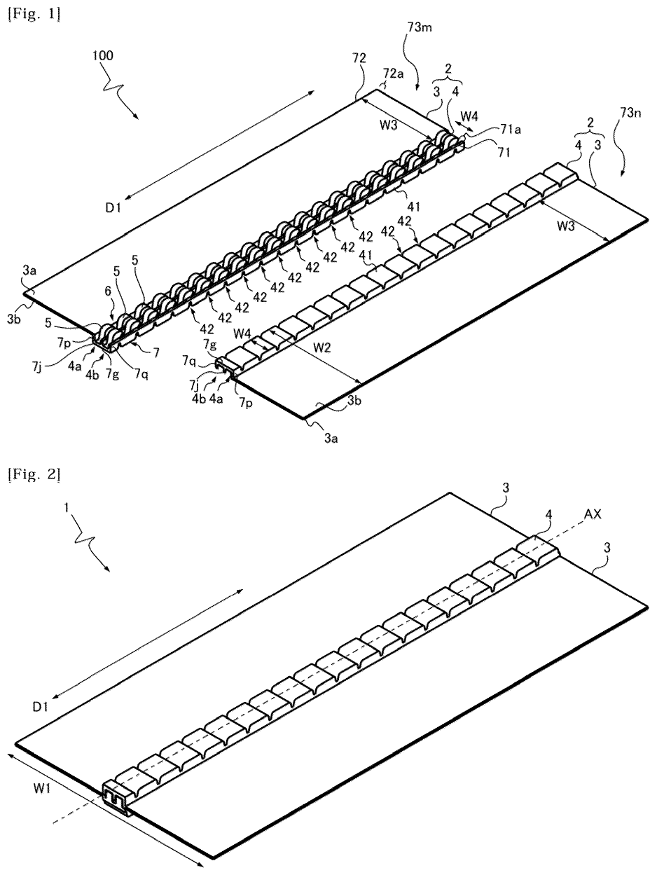

As illustrated in FIGS. 1 and 2, the fastening device 100 has a pair of composite stringers 2 and an optional slider 200 (See FIG. 5). The fastening device 100 is an elongated implement that extends, in a condition the composite stringers 2 are partially stacked and coupled, in the elongation direction D1 with a predetermined width W1. In the condition, the fastening device 100 has a flexibility and is bendable and flexible along its central line AX. Each composite stringer 2 is an elongated part that extends along the elongation direction D1 with a predetermined width W2. The composite stringer 2 has a flexibility and is therefore bendable and flexible in a width direction (a direction of double-headed arrow labelled with W1 in FIG. 2) and an elongation direction D1 (a direction of double-headed arrow labelled with D1 in FIGS. 1 and 2).

The fastening device 100 is attached to an article such as clothes, shoes, bags, suitcase or the like to effect opening and closing of the article. In particular, the composite stringers 2 of the fastening device 100 are secured to different portions of the article, allowing the different portions of the article to be coupled and decoupled based on coupling and decoupling of the respective composite stringers 2. The composite stringer 2 may be secured to a portion of the article by any method (e.g. sewing, adhering, and melting for attachment or a combination thereof). Note that the fastening device 100 may include the slider 200 for smooth coupling and decoupling of the composite stringers 2 one another, but the slider 200 may be omitted. The composite stringers 2 may be coupled and decoupled one another as operated by human hand without using the slider 200.

Each composite stringer 2 includes a tape portion 3 and a fastening portion 4 which are elongated in the front-rear direction and are arranged adjacently in the left-right direction. The tape portion 3 and the fastening portion 4 have certain widths W3 and W4 respectively, typically W3>W4 satisfied. The tape portion 3 and the fastening portion 4 extend continuously in the front-rear direction, allowing the use of combination of extruder and die wheel molding for a purpose of molding the tape portion 3 and the fastening portion 4. Thus, efficiency of production would be enhanced and simultaneously reduction of cost would be facilitated, compared with a slide fastener in which respective resin-made elements are formed through injection molding. With respect to a type of slide fastener in which resin-made elements are formed through injection molding, a process for producing a fastener tape and a process of injection molding of the elements to the fastener tape are performed separately in general, and simultaneous production is not possible.

The respective composite stringer 2 has, in its width direction, a first side edge 71 and a second side edge 72 opposite to the first side edge 71, and further has a first side edge portion 71a located nearby the first side edge 71 and a second side edge portion 72a located nearby the second side edge 72. Note that, the first side edge portion 71a is a side-edge portion of the fastening portion 4 located away from the tape portion 3. The second side edge portion 72a is a side-edge portion of the tape portion 3 located away from the fastening portion 4. In the fastening device 100, the first side edge 71 of the left-side composite stringer 2 is laid on the right-side composite stringer 2 in the up-down direction and similarly, the first side edge 71 of the right-side composite stringer 2 is laid on the left-side composite stringer 2 in the up-down direction.

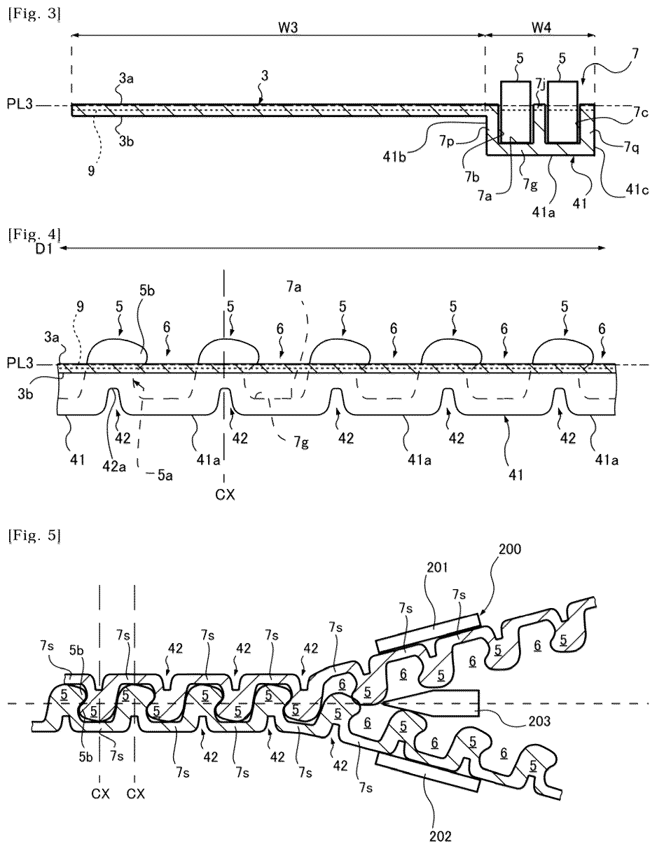

The respective composite stringer 2 has a first face 73m and a second face 73n as one and the other faces. The respective composite stringer 2 is a composite part of a sheet member 9 (illustrated as a dotted line in FIGS. 3 and 4) and a resin, and has a surface condition or appearance in accordance with the sheet member 9. In particular, the composite stringer 2 has a surface condition or appearance in accordance with the sheet member 9 on both sides of a boundary between the tape portion 3 and the fastening portion 4. Accordingly, with respect to the boundary between the fastening portion and the tape portion, the composite stringer is prevented from having different characteristic(s) (e.g. one or more characteristics selected from a group consisting of appearance, surface condition, softness and mechanical strength) between one and the other sides of the boundary. Note that, the surface condition and appearance of the composite stringer 2 may be observed as a pattern, unevenness, reflectivity and the like of the surface. The surface condition and appearance of the composite stringer 2 may be observed on one or both of top and bottom faces of the composite stringer 2, i.e. the above-noted first face 73m and/or the second face 72n. Additionally or alternatively, the surface condition and appearance of the composite stringer 2 may be observable on a side face of the composite stringer 2. Note that, the composite stringer 2 typically has four side faces defining its contour, with two side faces thereof extending in parallel to the elongation direction of the composite stringer 2 and the remaining two side faces extending in parallel to the width direction of the composite stringer 2, not limited to this though.

The tape portion 3 has a first tape face 3a on the same side as the first face 73m of the composite stringer 2, and a second tape face 3b on the same side as the second face 73n of the composite stringer 2, and a thickness thereof is defined by the first and second tape faces 3a and 3b. The fastening portion 4 includes plural fastening elements 5 arranged at predetermined pitch in the front-rear direction on the side of the first face 73m of the composite stringer 2, and gaps 6 are formed between the adjacent fastening elements 5 in the front-rear direction. Two or more arrays 4a,4b of fastening elements 5 may be arranged in the fastening portion 4 for a purpose of impeding fluid (e.g. water) flow through a space possibly caused between the engaged fastening portions 4 of the left and right composite stringers 2 and/or for a purpose of achieving a demanded engagement strength, but should not be limited to this. In another embodiment, a single array of fastening elements 5 is arranged in the fastening portion 4.

As illustrated in FIGS. 3 and 4, the fastening portion 4 has a groove 7 recessed from the first tape face 3a in a depth direction that matches the thickness direction of the tape portion 3. The groove 7 is open in the first face 73m and forms a box portion 41 protruding from the second tape face 3b in the second face 73n. The groove 7 and the box portion 41 each extends in the front-rear direction. Each fastening element 5 sits on the bottom surface of the groove 7 and/or is partially accommodated in the groove 7. The fastening elements 5 are arranged in the groove 7, thus reducing a thickness of the fastening portions 4 when the composite stringers 2 are coupled.

The groove 7 has sidewall plates 7p,7q arranged apart and opposed one another in the left-right direction (width direction) and a bottom plate 7g that interconnects the sidewall plates 7p,7q. The sidewall plates 7p, 7q extend in the depth direction of the groove 7 to define a depth of the groove 7. The sidewall plates 7p, 7q are positioned at the both edges of the bottom plate 7g in the left-right direction. A bottom end (also referred to as one end) of the sidewall plate 7p is connected to the edge of the bottom plate 7g, and a top end (also referred to as the other end) of the sidewall plate 7p is connected to the edge of the tape portion 3. A bottom end of the sidewall plate 7q is connected to the edge of the bottom plate 7g, and a top end of the sidewall plate 7q is a free end at the open side of the groove 7. The both top ends of the sidewall plate 7p and 7q may be positioned at the same height as the first tape face 3a. Note that the groove 7 may be omitted and the fastening elements 5 may be arranged on a plane coplanar to the first tape face 3a of the tape portion 3. In this case, the box portion 41 is not formed and this could be a flat surface. In cases where plural arrays 4a,4b of the fastening elements 5 are arranged, the groove 7 may include a partition wall 7j for a purpose of preventing incorrect engagement of the fastening elements 5 of the respective arrays 4a,4b and/or for a purpose of impeding fluid flow through the engaged composite stringers 2.

At the side of the first face 73m and/or the first tape face 3a, the groove 7 has a bottom surface 7a and sidewall surfaces 7b,7c standing at the both edges of the bottom surface 7a in the width direction. The fastening element(s) 5 is interposed between the sidewall surfaces 7b,7c. The groove 7 is arranged to form the box portion 41 at the side of the second face 73n and/or the second tape face 3b. The box portion 41 has a main surface 41a and sidewall surfaces 41b, 41c standing at the both edges of the main surface 41a in the width direction. The above-noted bottom plate 7g has (or is defined by) the bottom surface 7a and the main surface 41a, the sidewall plate 7p has (or is defined by) the sidewall surface 7b and the sidewall surface 41b, and the sidewall plate 7q has (or is defined by) the sidewall surface 7c and the sidewall surface 41c.

As illustrated in FIG. 4, each fastening element 5 includes a stem 5a standing in the thickness direction of the tape portion 3 (i.e. a direction orthogonal to the first and second tape faces 3a,3b), and an engagement protrusion 5b protruding from the stem 5a in the elongation direction D1 (i.e. forward or rearward). The gap 6 between adjacent fastening elements 5 is adapted to receive the fastening element 5 of engagement partner, i.e. is shaped to have a space for receiving the stem and a space for receiving the engagement protrusion. Note that, the protruding direction of engagement protrusion 5b of fastening element 5 may be altered between the arrays 4a,4b of the fastening elements 5.

In an example of FIG. 5, the engagement protrusion 5b of the top-side composite stringer 2 protrudes rearward (in a direction of decoupling the composite stringers 2) from the stem 5a along the central line AX, and a smooth slope is formed on the front side of the stem 5a where no protrusion for engagement is formed. On the other hand, the engagement protrusion 5b of the bottom-side composite stringer 2 protrudes forward (in a direction of coupling the composite stringers 2) from the stem 5a along the central line AX, and a smooth slope is formed on the rear side of the stem 5a where no protrusion for engagement is formed.

In cases where the fastening elements 5 are arranged on the bottom surface of the groove 7, the stem 5a is arranged to stand on that bottom surface, and the engagement protrusion 5b protrudes from the stem 5a (e.g. from its terminal portion) along that bottom surface. The engagement protrusion 5b is located higher than the tape portion 3 from the bottom surface of the groove 7. A notch is formed between the engagement protrusion 5b and the bottom surface of the groove 7 to which the engagement protrusion 5b of the fastening element 5 of engaging partner is fitted. Note that the fastening element 5 is arranged to have a clearance with the sidewall surface 7b,7c of the groove 7, thus ensuring smooth deformation of the fastening element 5.

On the second face 73n of the composite stringer 2, the above-noted box portion 41 may have clearance grooves 42 which are formed at pitch interval equal to the pitch interval of the stems 5a of the fastening elements 5. The clearance groove 42 is positioned on the central line CX of the stem 5a of the fastening element 5, and is recessed along the central line CX in the same direction as the stem 5a protrudes. Note that the pitch interval of the stem 5a is equal to interspace between the central lines CX of the respective stems 5a. In such a case where the clearance grooves 42 are formed on the box portion 41, the fastening element 5 would have much enhanced deformability, facilitating easier engagement of the fastening elements 5 one another. Also the fastening portion 4 is allowed to more smoothly flex toward the top and bottom sides. Number of the clearance grooves 42 is preferably equal to number of the fastening elements 5, but not necessarily limited to this. Depth of the clearance groove 42 may be adjusted as desired. In some cases, the bottom surface 42a of the clearance groove 42 is positioned closer to a plane PL3 (See FIG. 3) where the tape portion 3 is placed than a bottom surface 7a of the groove 7. The clearance groove 42 may have a depth that crosses through the bottom plate 7g of the groove 7 and reaches the base portion of the stem 5a.

The composite stringers 2 are coupled while the fastening portions 4 of the respective composite stringers 2 are being stacked. For example, the left and right composite stringer 2 are stacked in the up-down direction in their fastening portions 4, and the top-side and bottom-side fastening portions 4 are engaged as nipping force is applied by fingers or slider. As illustrated in FIG. 5, entry of the fastening element 5 of the left (first) composite stringer 2 into the gap 6 between the fastening elements 5 of the right (second) composite stringer 2 and entry of the fastening element 5 of the right (second) composite stringer 2 into the gap 6 between the fastening elements 5 of the left (first) composite stringer 2 are alternately repeated, and the fastening portions 4 are engaged one another along the elongation direction D1 based on the above-noted mutual engagements of the fastening elements 5. Disengagement between the fastening portions 4 and disengagement between the fastening elements 5 would be similarly understandable.

In cases where a slider 200 is used, the slider 200 has a first wing 201, a second wing 202, and a coupling pillar 203 between the wings. For example, a passage for one of the left and right composite stringers 2 is defined between the first wing 201 and the coupling pillar 203. A passage for the other one of the left and right composite stringers 2 is defined between the second wing 202 and the coupling pillar 203. The first wing 201 and the coupling pillar 203 are connected by a sidewall plate not-illustrated at a side where it does not interfere with the tape portion 3 of the composite stringer 2. The same holds true to the second wing 202 and the coupling pillar 203. Typically, the slider 200 has S-shaped cross section.

In the present embodiment, the composite stringer 2 includes at least one sheet member 9. In particular, the sheet member 9 is included in the respective ones of the tape portion 3 and the fastening portion 4 of the composite stringer 2 (e.g. it is arranged to cross a boundary between the tape portion 3 and the fastening portion 4 so as to effect such a condition). Furthermore, the composite stringer 2 has a surface condition or appearance in accordance with the sheet member 9 on the both sides of the boundary between the tape portion 3 and the fastening portion 4. Accordingly, with respect to the boundary between the fastening portion and the tape portion, the composite stringer is prevented from having different characteristic(s) (e.g. one or more characteristics selected from a group consisting of appearance, surface condition, softness and mechanical strength) between one and the other sides of the boundary. In cases where the sheet member 9 is not made of resin, the composite stringer 2 would be more easily sewn to an article such as clothes and bag and the like, thus avoiding cost and process burden for attachment of a sheet which is for preventing cracks, for example. If it is alternatively melted and attached to an article, it would be possible to select a type of the sheet member 9 which allows smoother melt-based attachment adapted for material of the article.

In a technical field of composite stringer produced based on combination of resin-extruding and die wheel, it has been conducted by skilled person that the sheet member 9 is selectively introduced in the tape portion 3 considering influence to molding of fastening portion 4 or obeying the conventional practice (this is particularly true in patent literature 1). In such a conventional practice particularly where the sheet member 9 modifies a surface of composite stringer 2, only the surface of tape portion 3 is selectively modified by the sheet member 9, resulting in difference in appearance or surface condition between the tape portion 3 and the fastening portion 4. Additionally, this results in difference in softness or mechanical strength. The present disclosure allows reduction or cancellation of such a difference.

Various manners may be embodied where the respective ones of the tape portion 3 and the fastening portion 4 include the sheet member 9. A manner of inclusion of the sheet member 9 in the tape portion 3 and a manner of inclusion of the sheet member 9 in the fastening portion 4 are not necessarily the same but it is envisioned that they are different. This is because there is a possibility that, while a fastening portion is molded by a die wheel, flection or break is locally caused in the sheet member 9 due to contact with the die wheel. Typically, in the tape portion 3, a resin layer and the sheet member 9 of the tape portion 3 are in an embedded, impregnated or laminated relation and similarly, in the fastening portion 4, a resin portion and the sheet member 9 of the fastening portion 4 are in the embedded, impregnated or laminated relation (the sheet member 9 is broken in the fastening portion 4 in an exemplary embodiment). The resin layer and the resin portion described herein indicate a portion made of resin of raw material (i.e. extruder-originated resin) other than the sheet member 9 of the composite stringer 2.

In some cases, in the tape portion 3 and/or in the fastening portion 4, the sheet member 9 is embedded in the resin, and the sheet member 9 is not directly exposed on the first and the second faces 73m, 73n of the composite stringer 2.

For example, the resin permeates into and through the sheet member 9, thereby the sheet member 9 is buried in the resin. As the sheet member 9 is embedded in the resin of the composite stringer 2, the surface condition of the composite stringer 2 may change. For example, in cases where the sheet member 9 is a woven fabric, knitted fabric or mixture thereof, the surface condition of the composite stringer 2 differs from a case where the sheet member 9 is omitted and a pattern in accordance with the sheet member 9 (e.g. woven pattern or knitted pattern or the combination thereof) emerges and is observable, as a result of permeation of the resin into the structure of the sheet member 9 (e.g. interstices defined between threads such as warp thread, weft thread or knitting yarn). A case is envisioned where such a pattern is not observed in one or both of top and bottom faces of the composite stringer 2 but is observed on a side face of the composite stringer 2.

In some cases, in the tape portion 3 and/or in the fastening portion 4, the sheet member 9 is impregnated with the resin. This encompasses a condition where the sheet member 9 and the resin are integrated as the resin permeates into the structure of the sheet member 9 (e.g. possible interstices between threads such as warp thread, weft thread or knitting yarn). In this case, the surface condition and appearance of the composite stringer 2 is substantially identical to the surface condition and appearance of the sheet member 9 but may be different from it due to influence of the resin inside of the sheet member 9. Note that, there is a benefit of waterproofness imparted to the tape portion 4 as the sheet member 9 is impregnated with the resin.

In some cases, the sheet member 9 and the resin layer are in laminated relation in the tape portion 3, and/or the sheet member 9 and the resin portion are in laminated relation in the fastening portion 4. The sheet member 9 is exposed on at least one face of the composite stringer 2, and the surface condition and appearance of the composite stringer 2 is substantially identical to the surface condition and appearance of the sheet member 9. The surface condition and appearance of the composite stringer 2 at the other face of the composite stringer 2 would be a resin surface of the resin layer or the resin portion. In this resin surface either, the pattern in accordance with the sheet member 9 may be observable. Note that, it would be possible to configure the composite stringer 2 by interposing the resin layer between two sheet members 9 so as to expose the sheet members 9 on both sides of the composite stringer 2.

Various embodiments are envisaged where the sheet member 9 is included in the fastening portion 4. It is not a requisite that the sheet member 9 or its broken piece(s) (e.g. fiber (a single fiber, a bundle of fibers and the like) of the structure) is included in every portion of the bottom plate 7g, the sidewall plate 7p,7q and the partition wall 7j of the groove 7, but it may be included in one or any combination of them. It is not a requisite that the sheet member 9 or its broken piece(s) is included in every fastening element 5 of the fastening portion 4, but it may be included in one or two or more fastening elements 5. It is also envisioned that the sheet member 9 exists selectively in the groove 7 only or in the fastening elements 5 only.

As seen in FIG. 3, the respective broken pieces of the sheet member 9 included in different fastening elements 5 (adjacent fastening elements 5 in the left-right direction in FIG. 3) may be positioned in or nearby a common plane. The sheet member 9 may be broken during the molding of the fastening portion 4 as spaces are formed between the fastening elements 5. However, these broken pieces are originally different portions of a same sheet member 9, and may be positioned in or nearby a common plane even after the molding. Of course, it is envisioned that the broken pieces exist at completely different heights even in the adjacent fastening elements 5 owing to extruding pressure and speed of resin, or rotational speed of die wheel.

Preferably, the sheet member 9 is made of porous material (i.e. resin-penetratable or permeable material) which allows permeation of resin into or through the sheet member 9. It should be noted that, even if a sheet member 9 does not have such resin-penetratable or resin-permeable characteristic, it would be possible to impart resin-permeable characteristic to the sheet member 9 by forming a series of holes in the sheet member 9. Additionally to the above-described woven fabric, knitted fabric and the mixture thereof, a sheet member 9 may be a resin sheet used for heat sealing, a foam layer or a paper. Note that number of the sheet member 9 in the composite stringer 2 is not limited to one but may be two or more. The sheet member 9 is not limited to a single layer sheet but may be a laminate sheet. For example, the sheet member 9 is a laminate sheet in which a coating film is formed on a woven fabric.

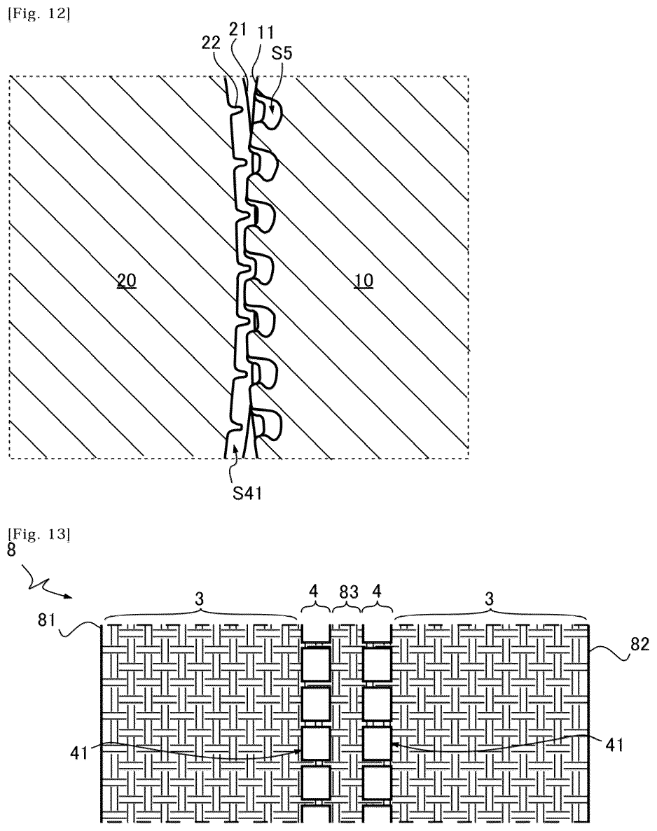

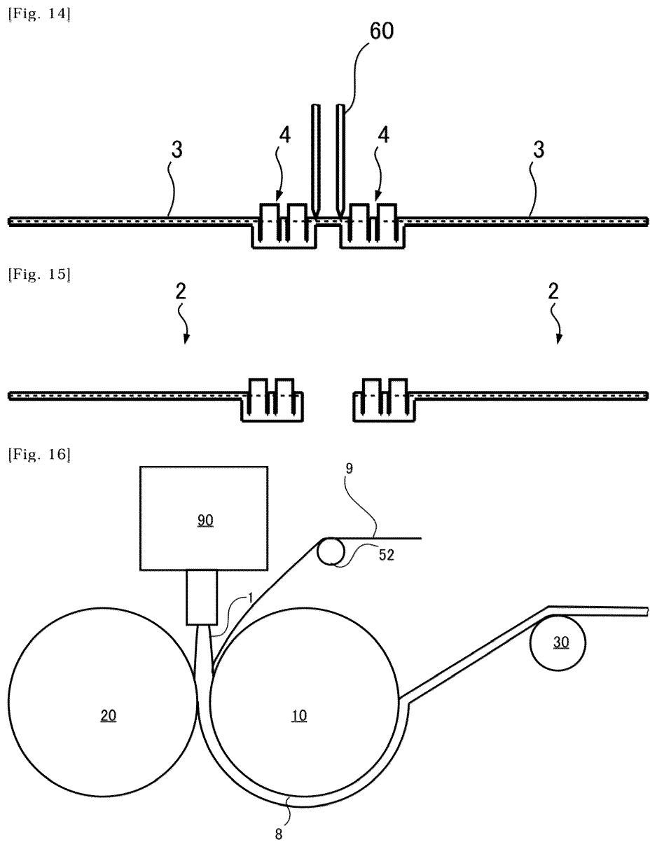

Hereinafter, an apparatus and method for production of composite stringer 2 would be discussed with reference to FIGS. 6-15. Apparatus for production of composite stringer 2 has a first die wheel 10, a second die wheel 20, an extruder 90, a guide rod 51, and a guide roll 30. The first die wheel 10 is secured to a rotational axis of motor (not illustrated) and rotates counterclockwise centered about the rotational axis. The second die wheel 20 is secured to a rotational axis of motor (not illustrated) and rotates clockwise (i.e. in a direction opposite to the rotational direction of the first die wheel) centered about the rotational axis. As a result, a material (particularly a resin) supplied into an interspace between the first die wheel 10 and the second die wheel 20 can be compressed between the both wheels. Minimum interspace may be set between the first and second die wheels 10 and 20 to allow the tape portion 3 of the composite stringer 2 to have a predetermined thickness. That is, the tape portion 3 may have a thickness substantially equal to the minimum interspace set between the first and second die wheels 10 and 20. For a purpose of appropriately positioning the second die wheel 20 relative to the first die wheel 10, a control mechanism may be employed that regulates a position of the rotational axis of the second die wheel 20 relative to the first die wheel 10.

The extruder 90 extrudes a resin onto a circumferential surface 11 of the first die wheel 10 (into the interspace between the first and second die wheels 10 and 20 here). The extruder 90 has a screw (not-illustrated), and discharges the resin 1 via its discharging mouth 91 (typically toward a ground side in a vertical direction) as the screw rotates. The resin 1 may be discharged as a resin layer having a predetermined width (a width equal to a total width of first and second molding belts described below or equal to or greater than a multiple of the total width). The resin 1 may be formed as a resin portion substantially layered on a predetermined area (e.g. an area having an angular range of 150-210°) of the circumferential surface 11 along the circumferential direction of the first die wheel 10.

Simultaneously as supplying the resin 1 onto the circumferential surface 11 of the first die wheel 10 (into the interspace between the first and second die wheels 10 and 20 here), the sheet member 9 is fed onto the circumferential surface 11 of the first die wheel 10 (into the interspace between the first and second die wheels 10 and 20 here). The resin 1 and the sheet member 9 are supplied onto the circumferential surface of the first die wheel 10 in a manner that they are stacked thereon and as a result, the composite stringer 2 is formed. The sheet member 9 has a width that is equal to a total width of first and second molding belts described below or equal to or greater than a multiple of the total width.

Whether the sheet member 9 and the resin 1 are in embedded, impregnated or laminated relation may depend on a material of the sheet member 9, an amount of supplied resin per unit time, cavity structures of the first and second die wheels 10 and 20 and the like. In some cases, in a primary molded part 8 (similarly each composite stringer 2 therein), a first region of the sheet member 9 is at least partially embedded in the resin layer of the tape portion 3, or the first region of the sheet member 9 is impregnated with the resin of the tape portion 3 or the first region of the sheet member 9 is laminated onto a resin layer of the tape portion 3. At least a part of a second region of the sheet member 9 or broken piece of the sheet member 9 may be embedded in the resin portion of the fastening portion 4; or at least a part of a second region of the sheet member 9 or broken piece of the sheet member 9 may be impregnated with the resin of the fastening portion 4; or a second region of the sheet member 9 or broken piece of the sheet member 9 may be laminated onto a resin portion of the fastening portion 4. The second region of the sheet member 9 may be a region directly adjacent to the first region of the sheet member 9. A part of the second region of the sheet member 9 may be positioned in the side-edge portion of the fastening portion 4 distal to the tape portion 3, and a part of the second region of the sheet member 9 may be exposed in the side-edge portion (e.g. side face) or a pattern in accordance with the sheet member 9 may emerge and be observable in the side-edge portion (e.g. side face).

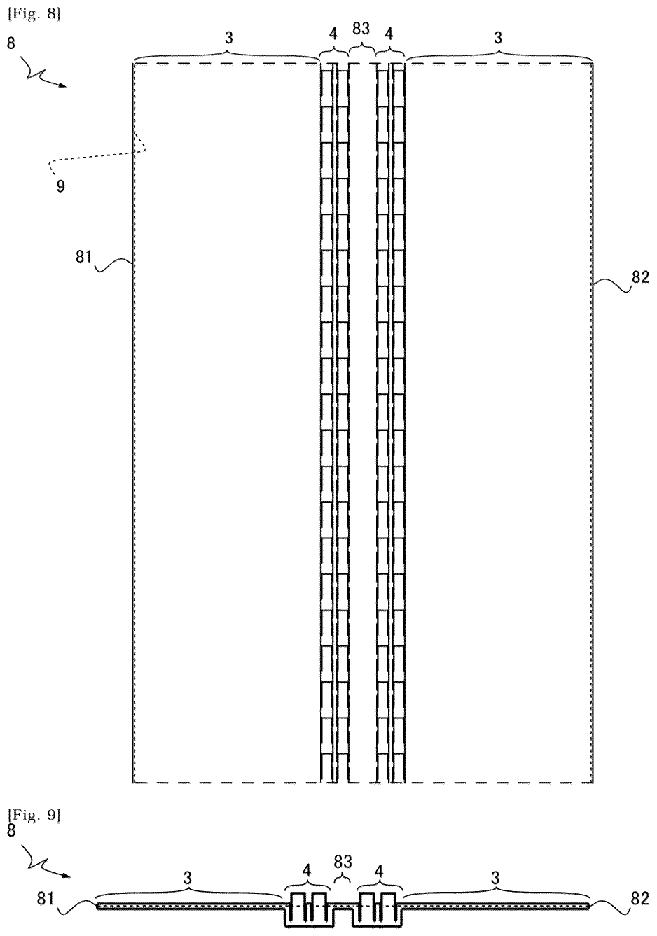

The apparatus for producing composite stringer 2 produces a primary molded part 8 made of one composite stringer 2 or a primary molded part 8 including plural composite stringers 2. In a case shown in FIGS. 8 and 9, a primary molded part 8 is produced where the composite stringers 2 are interconnected in a width direction. In this primary molded part 8, a tape portion 3, a fastening portion 4, a coupling portion 83, a fastening portion 4, and a tape portion 3 are arranged in this order in the width direction. Two composite stringers 2 would be obtained by cutting out or by splitting in and along the coupling portion 83 of the primary molded part 8. The two fastening portions 4 are located in the center area of the first and second die wheels 10,20 in the width direction, and thus defective molding (e.g. sink mark) of the fastening elements 5 is suppressed compared with a case where the fastening portions 4 are located in the side area of the primary molded part 8 in the width direction.

The sheet member 9 may be arranged in the entire width of the primary molded part 8. This avoids a burden of supplying sheet members 9 respectively for composite stringers 2, and the efficiency of production of composite stringer 2 would be enhanced. Note that, the primary molded part 8 has a first side edge 81 and a second side edge 82 in its width direction, by which a width thereof is defined.

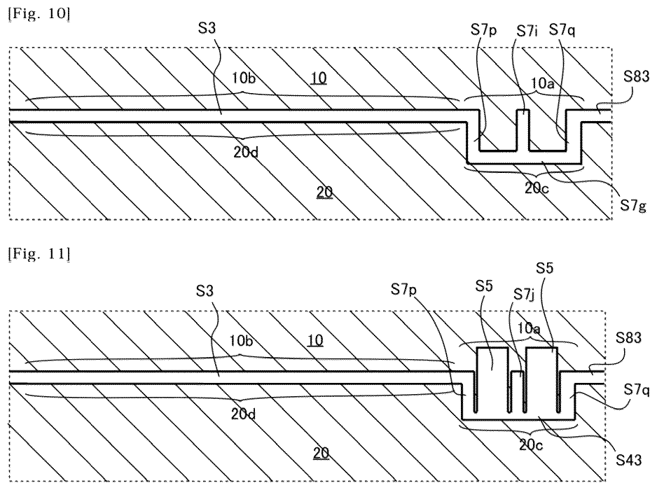

Descriptions follows with reference to FIGS. 10-12. The circumferential surface 11 of the first die wheel 10 includes first and second molding belts 10a, 10b which are adjacent in the width direction of the first die wheel 10 and extend in the circumferential direction of the first die wheel 10. The width direction of the first die wheel 10 is a direction parallel to the rotational axis of the first die wheel 10. The first molding belt 10a is adapted for molding the fastening portion 4 (more particularly is shaped to have a molding surface that (at least partially) define mold cavities for the fastening elements 5), and the second molding belt 10b is adapted for molding or forming the tape portion 3 (more particularly is shaped to have a molding surface that (at least partially) define a mold cavity for the tape portion (or to have a flat surface that is parallel to the rotational axis of the first die wheel 10). The circumferential surface 21 of the second die wheel 20 includes a third molding belt 20c which is adapted for molding the fastening portion 4 together with the first molding belt 10a of the first die wheel 10 (more particularly is shaped to have a molding surface that (at least partially) define a mold cavity for the box portion 41). The circumferential surface 21 of the second die wheel 20 includes a fourth molding belt 20d adapted to mold the tape portion 3 together with the second molding belt 10b of the first die wheel 10 (more particularly is shaped to have a molding surface that (at least partially) define a mold cavity for the tape portion (or to have a flat surface that is parallel to the rotational axis of the second die wheel 20).

The first molding belt 10a includes molding cavities S5 adapted for molding the respective fastening elements 5. The first molding belt 10a also includes molding cavity S7j adapted for molding the partition wall 7j. The third molding belt 20c includes a molding cavity S41 adapted for molding the box portion 41. The third molding belt 20c may include protrusions 22 for molding the clearance grooves 42. The second molding belt 10b and the fourth molding belt 20d are opposed to define a molding space S3 for molding the tape portion 3. Recess cavity may be provided in one or both of the second and fourth molding belts 10b and 20d to increase a thickness of the tape portion 3.

Note that there are sets of first to fourth molding belts 10a, 10b,20c,20d on the both sides of a molding cavity S83 for molding the coupling portion 83 in the primary molded part 8, but only one set is illustrated in FIGS. 10 and 11 for the sake of convenience of illustration. That is, the circumferential surface 11 of the first die wheel 10 includes a first belt including the first and second molding belts 10a and 10b, and a second belt including further first molding belt with a molding surface identically configured as the first molding belt 10a and a further second molding belt with a molding surface identically configured as the second molding belt 10b. The first molding belt 10a and the further first molding belt are spatially connected via the molding cavity S83. The circumferential surface 21 of the second die wheel 20 includes a further third molding belt with a molding surface identically configured as the third molding belt and a further fourth molding belt with a molding surface identically configured as the fourth molding belt. There further third and fourth molding belts are adapted to mold the fastening portion and the tape portion together with the further first and second molding belts of the first die wheel 10. The resin 1 is filled between the first and second die wheels 10 and 20 (into a space defined by the first to fourth molding belts, a space defined by the further first to fourdh molding belts, and the molding cavity S83), and subsequently solidifies as being cooled in air or water and the like. As such the resin 1 is molded into a shape in accordance wit those molding belts.

In the present embodiment, the sheet member 9 is fed onto the circumferential surface 11 of the first die wheel 10 (e.g. into the interspace between the first and second die wheels 10 and 20) so as to at least partially cover the respective ones of the first and second molding belts 10a, 10b and so as to cross a boundary between the first and second molding belts 10a, 10b. As a result, the surface of the composite stringer 2 is modified not only in the tape portion 3 but also in the fastening portion 4, reducing a difference in appearance or surface condition between the tape portion 3 and the fastening portion 4. The sheet member 9 is included in the fastening portion 4 either and as a result, difference in softness and/or mechanical strength between the tape portion 3 and the fastening portion 4 may also be reduced. In cases where the second die wheel 20 is used, the sheet member 9 is supplied onto the circumferential surface 11 of the second die wheel 20 (e.g. into the interspace between the first and second die wheels 10 and 20) so as to cover the third and fourth molding belts 20c,20d additionally.

The primary molded part 8 has a surface condition or appearance in accordance with the sheet member 9 (e.g. see FIG. 13). In FIG. 13, the sheet member 9 is a woven web, and a woven pattern in accordance with the warp and weft threads emerges on one or both sides of the primary molded part 8. Note that the instant figure depicts only one side of the primary molded part 8, but a pattern in accordance with the sheet member 9 emerges also on the other side. A case where the sheet member 9 is a knitted fabric would be similarly understandable. In a case where the sheet member 9 is not supplied, the composite stringer 2 would have resin surfaces only. As the composite stringer 2 includes the sheet member 9, the surface condition or appearance of the composite stringer 2 can be modified. In particular, the sheet member 9 is included in both of the tape portion 3 and the fastening portion 4. In FIG. 13, a pattern in accordance with the sheet member 9 is not illustrated in the box portions 41, but a pattern similar to one in the tape portion 3 may emerge or a broken piece of the sheet member 9 may be contained therein. Alternatively, there is a case as shown in FIG. 13 where the pattern in accordance with the sheet member 9 does not emerge on the surface of the box portion 41 but emerges between adjacent box portions 41. As a result of this, the composite stringer 2 may have a surface condition or appearance in accordance with the sheet member 9 on the both sides of the boundary between the tape portion 3 and the fastening portion 4 at least on one face thereof (preferably on the both faces thereof). In cases where the sheet member 9 has resin-penetratable or resin-permeable characteristic, the resin 1 permeates into and through the sheet member 9, and the fastening elements 5 or the box portions 41 can be molded as intended.

In cases where the primary molded part 8 includes a single composite stringer 2, the primary molded part 8 may be cut to have a desired length so that a composite stringer 2 of the desired length is obtained. In cases where the primary molded part 8 includes plural composite stringers 2, a cutter 60 is used to cut out the coupling portion 83 or to form a cut line in and along the coupling portion 83 so that the respective composite stringers 2 can be obtained from the primary molded part 8 as appreciated from FIGS. 14 and 15. The cutter 60 may be arranged at the side of the second face of the primary molded part 8. Due to the cutting of the above-described primary molded part 8, the sheet member 9 may be exposed at a side face of the composite stringer 2 (along the elongation direction or the width direction). Note that when the cutting line is formed in the coupling portion 83, a part of the coupling portion 83 connected to the sidewall plate 7q may remain as one side-edge portion of the composite stringer 2. Two composite stringers 2 obtained through cutting as shown in FIGS. 14 and 15 are stacked on top of each other such that the fastening elements 5 of the respective composite stringers 2 are opposed, thereby configuring the fastening device 100.

As understood from the above descriptions, a method of producing a composite stringer disclosed in the present specification includes: (i) an extruder extruding a soft or molten resin toward a circumferential surface of die wheel and supplying the resin on the circumferential surface of the die wheel; and (ii) feeding at least one sheet member onto the circumferential surface of the die wheel simultaneously as supplying the resin onto the circumferential surface of the die wheel. In a case where a pair of die wheels is used, the resin and the sheet member are supplied to an interspace between them. In either way, the sheet member is fed onto the circumferential surface of the die wheel so as to at least partially cover the respective ones of the first and second molding belts and to cross a boundary between the first and second molding belts. As a result, the composite stringer may have, on at least one face thereof, a surface condition or appearance in accordance with the sheet member on the both sides of the boundary between the tape portion and the fastening portion.

Supply pressure, supply amount per unit time, coefficient of viscosity, temperature and the like of the resin 1 would be properly determined by a skilled person in the art. Transfer speed of the sheet member 9, tension applied to the sheet member 9 and the like would also be properly determined by a skilled person in the art. Rotational speeds of the first and second dies 10 and 20, a distance between them and the like would also be properly determined by a skilled person in the art. Note that the transfer speed of the sheet member 9 is not necessarily equal to the speed of extruding of the resin 1, and may be faster in some cases. The primary molded part 8 may be cooled by air or water at a position vertically under the first die wheel 10. Accordingly, the primary molded part 8 is prevented or suppressed from deforming when delaminated from the first die wheel 10.

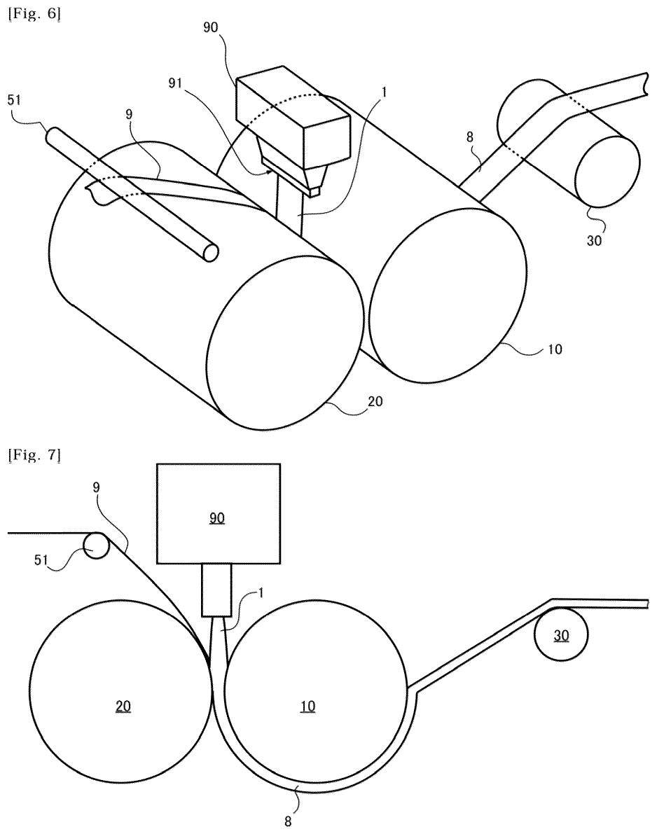

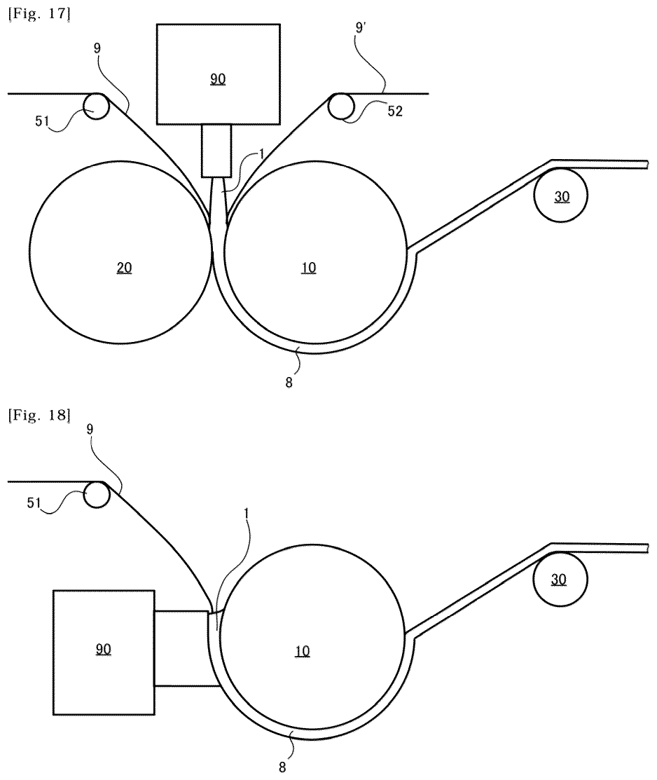

Unlike FIG. 7, the sheet member 9 may be fed from a side of the fist die wheel 10 as shown in FIG. 16. The sheet member 9 used has resin-penetratable or resin-permeable characteristic. The resin 1 may flow into the respective molding cavitys of the first and second molding belts 10a and 10b through the sheet member 9. As shown in FIG. 17, first and second sheet members 9 may be respectively fed from the sides of the first and second die wheels 10 and 20. One composite stringer 2 may include two sheet members 9 corresponding to the top and bottom faces of the composite stringer 2. This brings the surface texture at the both top and bottom faces of the composite stringer 2 closer to the surface texture of the sheet member 9. In this case, the resin permeates into and through the respective sheet members 9 and a resin layer may be formed between the sheet members 9 (3 layer structure may be formed in the tape portion 3 which includes the sheet member impregnated with the resin, the resin layer, and another sheet member impregnated with the resin). As shown in FIG. 18, the discharging mouth of the extruder 90 may be arranged to confront the circumferential surface 11 of the first die wheel 10, and the sheet member 9 may be fed to the interspace between the first die wheel 10 and the discharging mouth of the extruder 90.

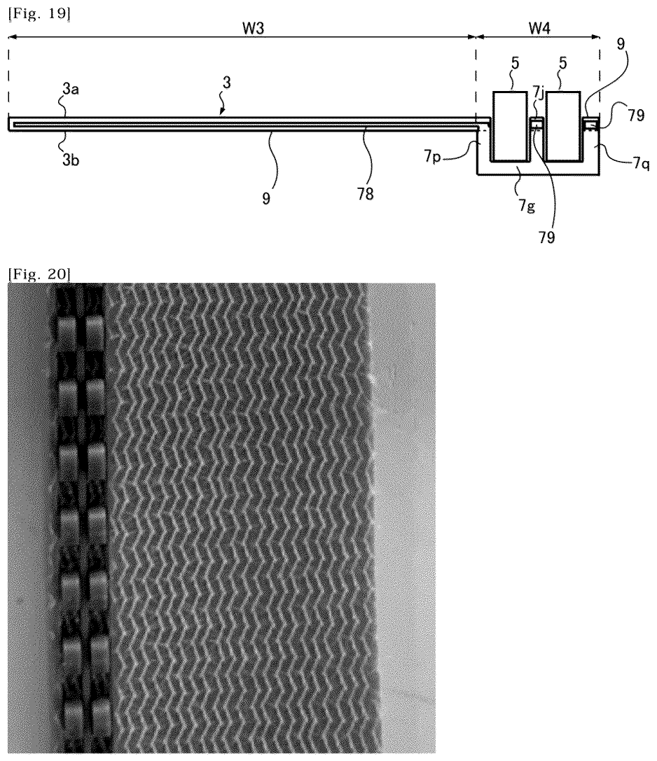

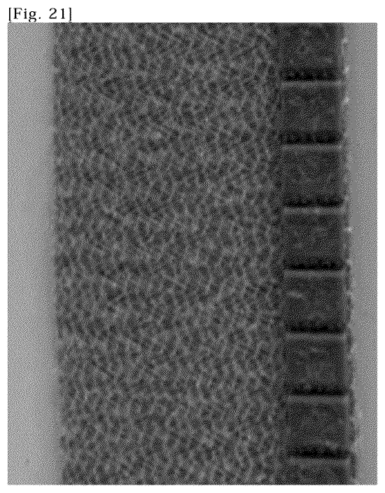

Further description follows by way of precaution. FIG. 3 depicts that the sheet member 9 is embedded in the resin layer of the tape portion 3 and the resin portion of the fastening portion 4. However, if the sheet member 9 is thick as shown in FIG. 19, an embodiment is envisaged where the sheet member 9 is impregnated with the resin (or a resin layer 78 is embedded in the sheet member 9) in the tape portion 3, and the sheet member 9 is impregnated with the resin (or a resin portion 79 is embedded in the sheet member 9) in the fastening portion 4. If the sheet member 9 is broken when compressed between the first and second die wheels 10 and 20, a broken piece of the sheet member 9 may be contained in the resin portion of the fastening portion 4 (e.g. fastening element 5 or groove 7 or box portion 41). Advantageously, the resin portion of the fastening portion 4 may have an appearance similar to the appearance of the tape portion 3.

### WORKING EXAMPLE 1

The apparatus for production shown in FIG. 17 was used to produce the primary molded part 8 shown in FIGS. 8 and 9. Next, the primary molded part is cut as shown in FIG. 14, and the respective composite stringers are obtained and are cut to have desired length. A knitted fabric was employed as the sheet member. The composite stringer obtained as such had a first tape face where a pattern in accordance with the knitted fabric as shown in FIG. 20 emerged. Similarly, on the second tape face of the composite stringer, a pattern in accordance with the knitted fabric as shown in FIG. 21 emerged and further a raised nap, originating from fibers of the knitted fabric, emerged. In particular, a pattern in accordance with the knitted fabric was observable in the both of the tape portion and the fastening portion. A pattern in accordance with the knitted fabric was observable also in the side-edge portion of the fastening portion of the composite stringer. A pattern in accordance with the knitted fabric was observable also in the bottom surface of the groove between the fastening elements along the elongation direction or in the sidewall surface thereof. Fibers, originating from the knitted fabric, were observable on the box portion (particularly the main surface thereof). One or any combination of the above-noted results of observation would be understandable as distinctive features originating from the presently disclosed method of production (without requiring association with other features of the present disclosure).

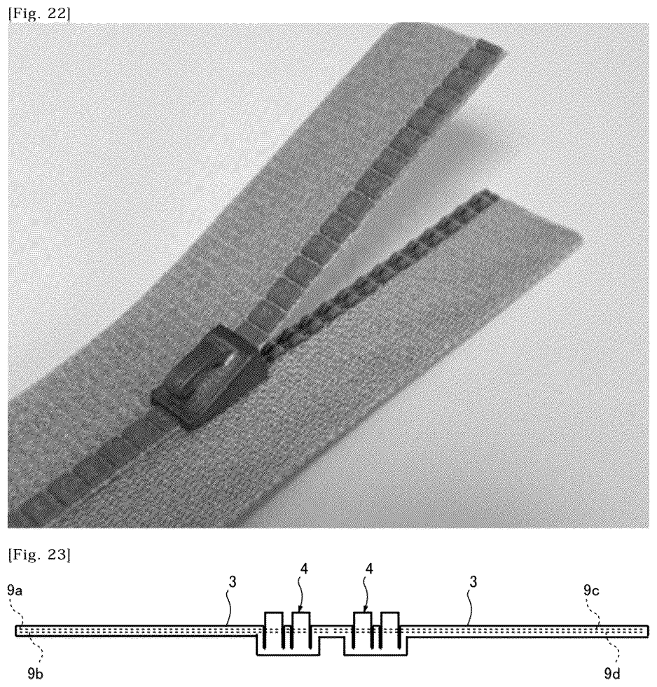

FIG. 22 presents a photograph of fastening device in which a slider is attached to a pair of composite stringers. The composite stringer 2 has a texture alike the texture of the sheet member 9 in both of the tape portion 3 and the fastening portion 4, unlike resin surface with inorganic appearance.

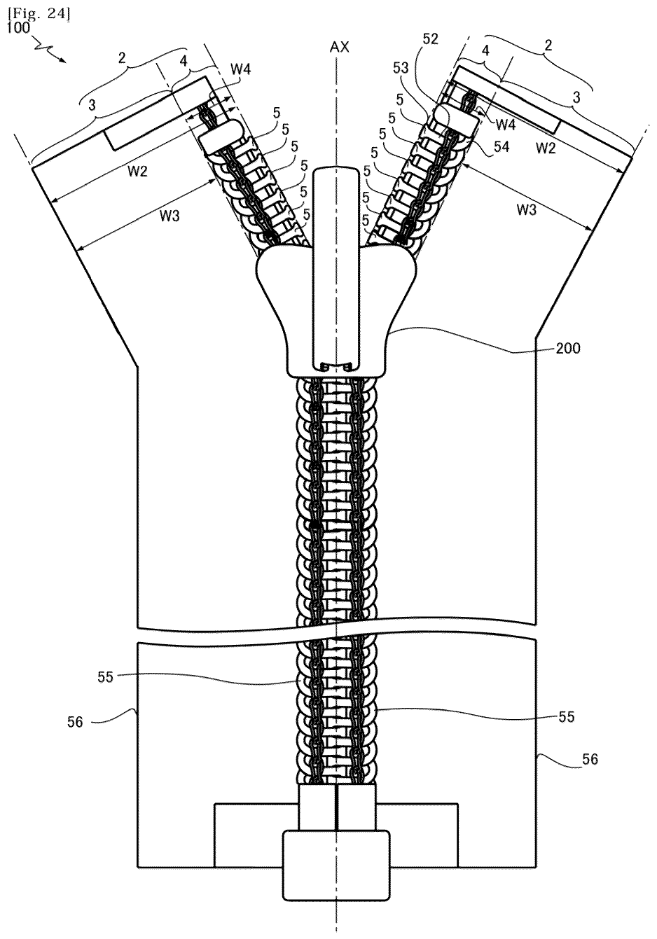

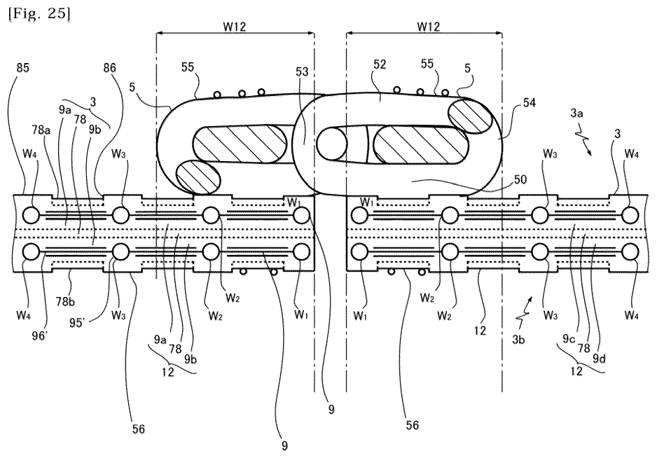

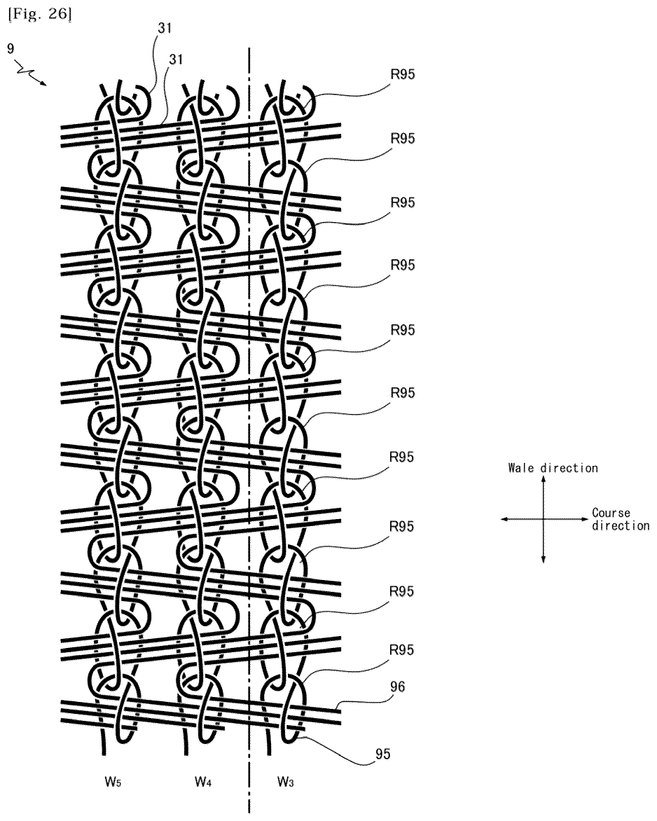

FIG. 23 depicts an embodiment where the primary molded part 8 includes 4 sheet members 9 in accordance the method shown in FIG. 17. In the present embodiment, the sheet member 9a-9d each includes woven and/or knitted structure, and has different appearances on the both top and bottom faces thereof. When used as the fastening device 100, one composite stringer 2 is reversed relative to the other one for use. In the present embodiment, the sheet members 9 which are in upside down relationship are included in each composite stringer 2 used for the pair so as to avoid that difference in appearance between the top and bottom faces of the sheet member 9 causes a difference in appearance of the left and right composite stringers 2 of the fastening device 100. For example, the sheet member 9d is upside down relative to the sheet member 9a. When the primary molded part 8 of FIG. 23 is cut into left and right composite stringers 2 and these are coupled, the sheet member 9d is reversed and the bottom surface of the sheet member 9d would be the top surface. As a result, difference in appearance between the left and right composite stringers 2 is reduced in the fastening device 100. Additionally or alternatively to the reversed relationship between the sheet members 9a and 9d, the sheet member 9c may be reversed upside down relative to the sheet member 9b. Also, in stead of reversing the sheet member 9 upside down with respect to the top and bottom faces of the primary molded part 8, a direction of protruding of the engagement protrusion 5b may be reversed between one fastening portion 4 and the other fastening portion 4 in the primary molded part 8.

In some above-described embodiments, the tape portion 3 of the composite stringer 2 has surface conditions in accordance with the sheet member 9 in the both top and bottom faces thereof. In particular, in a case shown in FIG. 19, a resin layer is formed inside the sheet member 9 in the tape portion 3, and the surface conditions of the top and bottom tape faces are substantially equal to the surface conditions of the sheet member 9. In the case of the working example shown in FIGS. 20 and 21, the tape portion 3 includes two knitted fabrics, and patterns in accordance with the knitted fabrics emerge on the both tape faces of the tape portion 3 owing to its high resin-penetratable and resin-permeable characteristic. Also, raised nap originating from fibers of the knitted fabric emerges in FIG. 21.

As a summary of the above-described features, the tape portion 3 includes at least one sheet member 9 and a resin 78 that adheres to the at least one sheet member 9 and is formed as a layer along the at least one sheet member 9. The at least one sheet member 9 has a resin-permeable (resin penetrable) structure. The resin 78 permeates the structure of the at least one sheet member 9. The tape portion 3 has surface conditions in accordance with the structure of the at least one sheet member 9 in both of the first and second tape faces 3a,3b based on the permeation of the resin 78 into the structure of the at least one sheet member 9. According to this embodiment, the sheet member 9 is utilized to easily improve the surface conditions of the top and bottom faces of the tape portion 3. Typically, material of the sheet member 9 is properly selected to modify the surface conditions of the both faces of the tape portion 3, and a texture and/or appearance in accordance with the material of the sheet member 9 is imparted to the tape portion 3. As a non-limitting technical effect, despite of a fact that the tape portion 3 includes the resin, the respective top and bottom tape faces thereof are not formed as a typical resin surface (e.g. smooth flat resin surface) owing to the influence of the sheet member 9. Note that the fastening portion 4 may not include the sheet member 9 but of course, may include it. Typically, the tape portion 3 is wider than the fastening portion 4, and has a thickness defined by the first and second tape faces 3a,3b.

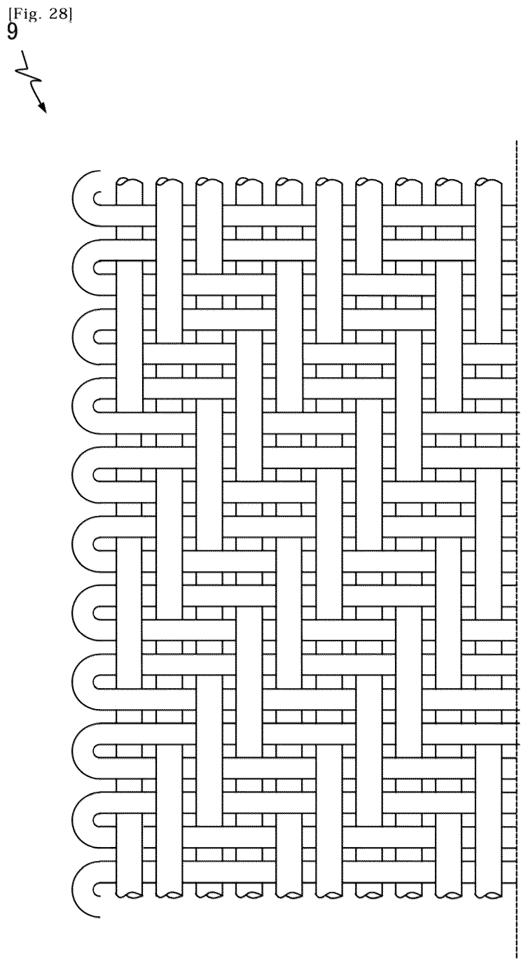

Hereinafter, FIGS. 24 to 33 will be referred for further description. As shown in FIG. 24, the fastening device 100 is a slide fastener with a pair of left and right composite stringers 2, and a slider 200 attached to the pair of left and right composite stringers 2. The slider 200 moves frontward to couple the left and right composite stringers 2, and the slider 200 moves rearward to decouple the left and right composite stringers 2. The slider 200 includes a top wing, a bottom wing, a coupling pillar coupling these wings, a pair of top flanges defining a width of element passage in the left-right direction, and optionally a pair of bottom flanges defining the width of the element passage in the left-right direction.

The composite stringer 2 is elongated in the front-rear direction, and can be sectioned into a tape portion 3 and a fastening portion 4 in its width direction.

In more detail, the composite stringer 2 can be sectioned into the tape portion 3 and the fastening portion 4 when viewed in a thickness direction (i.e. as in FIG. 24) which is orthogonal to the elongation and width directions of the composite stringer 2. The tape portion 3 and the fastening portion 4 have predetermined widths W3, W4 respectively, and W3>W4 is typically satisfied (this feature is same as in FIG. 1).

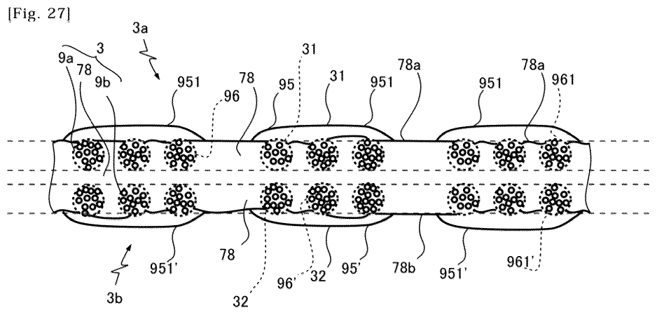

The tape portion 3 includes at least one sheet member 9, and a resin 78 that adheres to the at least one sheet member 9 and is formed as a layer along the at least one sheet member 9. As shown in FIG. 25, the sheet member 9 and the resin 78 overlap in the up-down direction. The sheet member 9 is a flexible member two dimensionally expanding in the elongation and width directions of the composite stringer 2, and extends longer in its elongation direction with a width substantially equal to the width of the composite stringer 2. Likewise the sheet member 9, the resin 78 is two dimensionally expanding in the elongation and width directions of the composite stringer 2. The resin 78 is typically formed as a resin layer, but it is not a requisite to be continuous in its two-dimensional expanse and may be discontinuous locally or intermittently or randomly. Preferably, the resin 78 is formed thin to impart flexibility to the tape portion 3 and for example, its maximum thickness is equal to or less than 5 times or 3 times a maximum thickness of one sheet member 9. Also, the resin 78 is selected from an appropriate resin material so as to be penetratable and permeable into the structure of the sheet member 9 (e.g. thermoplastic resin such as polyester elastomer, polybutylene terephthalate (PBT), polyacetal (POM), polypropylene (PP), polyethylene (PE)) and its viscosity when melted is also adjusted appropriately. Considering softness and durability, thermoplastic polyester elastomer is preferred. As a matter of course, the resin 78 indicates a resin portion which is distinctive/separate to a resin material of the sheet member 9 (e.g. a resin material forming knitting yarn).

In a non-limitting example, a thickness of the resin 78 is in a range between 0.1 and 0.4 mm, a thickness of the sheet member 9 is in a range between 0.1 and 0.3 mm, and a total thickness of the tape portion 3 is in a range between 0.2 and 0.7 mm. In a preferred embodiment, a total thickness of the tape portion 3 is about 0.4 mm in a condition where the resin 78 permeates the sheet member 9.

In some cases, the at least one sheet member 9 includes first and second sheet portions 9a,9c and 9b,9d which respectively have resin-permeable (and/or resin-penetratable) structure, and the first and second sheet portions 9a,9c and 9b,9d overlap via the resin 78. The resin 78 permeates each structure of the first and second sheet portions 9a,9c and 9b,9d, and the tape portion 3 has a surface condition of the first tape face 3a in accordance with the first sheet portion 9a,9c and a surface condition of the second tape face 3b in accordance with the second sheet portion 9b,9d. A thin sheet member 9 is used as such to effectively improve the surface conditions of both top and bottom faces of the tape portion 3. In more detail, material of the first sheet portion 9a,9c is selected to modify the texture of the first tape face 3a and similarly, the texture of the second tape face 3b is modified based on selection of the second sheet portion 9b,9d.

The first tape face 3a may be a hybrid surface of a resin surface 78a of the resin 78 and an exposed portion 951,961 of the first sheet portion 9a, 9c that is partially covered by the resin 78. Likewise, the first tape face 3b may be a hybrid surface of a resin surface 78b of the resin 78 and an exposed portion 951′,961′ of the second sheet portion 9b,9d that is partially covered by the resin 78. The resin surface 78a ensures the waterproofness and simultaneously, the sheet portion is partially exposed so that the texture of the sheet portion is imparted to the tape face. Note that in order to have a portion of the first sheet portion 9a, 9c covered by the resin 78 and to have a remaining portion thereof exposed, the first sheet portion 9a, 9c preferably has non-flat sheet surface. The same applies to the second sheet portion 9b,9d.

Preferably, the first sheet portion 9a,9c is a woven or knitted fabric but not limited to this. For example, the first sheet portion 9a,9c may be a nonwoven fabric. The same applies to the second sheet portion 9b,9d. The first sheet portion 9a,9c and the second sheet portion 9b,9d are not necessarily of same material but may be of different material. For example, the former is a knitted fabric and the latter is a woven fabric, and vice versa. Number of sheet member 9 in a tape portion 3 is preferably two, but three or more may be included in a tape portion 3 dependent on the degree of resin-permeability of the sheet member 9.

Surface condition of at least one of the first and second tape faces 3a,3b of the tape portion 3 may impart a tactile sense of fibers. In this case, compatibility with an article (e.g. garment, bag or shoes) to which the fastening device 100 is attached may be enhanced. With respect to a location where the composite stringer 2 is attached, similarity may be ensured not only for appearance between the garment and the tape portion 3 but also for a tactile sense when touched by human hand, for example. Note that, in this case either, the tape portion 3 includes the resin 78 as described above, thus ensuring waterproofness (water insulating characteristic) of the tape portion 3.

When moisture is applied to a surface of the tape portion 3, the moisture is in contact with or permeates the fibers on the surface of the tape portion 3 and the tape portion 3 becomes wet. However, even in such a case, the moisture does not immediately permeate the tape portion 3. In more particular, even if the moisture is applied to the first tape face 3a, the moisture is prevented by the resin 78 of the tape portion 3 from reaching to the second tape face 3b (it may reach via an interspace between the composite stringers 2). As stated at the beginning, the inorganic appearance of resin surface tends to be evident as the waterproofness of slide fastener is strengthened. The above-described feature allows the fastening device 100 to have some level of waterproofness and simultaneously the enhanced compatibility with the articles. This involves a huge possibility to realize actual commercial need.

The fastening portion 4 includes fastening elements 5 and a supporting portion 12 separate to the fastening elements 5. The supporting portion 12 is at least partially coupled to the tape portion 3 in a same layer, and includes an extended portion of the sheet member 9 of the tape portion 3 to the fastening portion 4 and an extended portion of the resin 78 of the tape portion 3 to the fastening portion 4. In some cases, each tape portion 3 of the composite stringer 2 includes two sheet members 9, and the fastening portion 4 includes two sheet members 9. Each sheet member 9 of the two sheet members 9 is formed continuously across the tape portion 3 and the supporting portion 12 of the fastening portion 4. As such, the tape portion 3 and the supporting portion 12 are the same in configuration despite of difference in position and extent in the width direction of the composite stringer 2. The tape portion 3 and the supporting portion 12 would be collectively referred to as a fastener tape 56. Note that, difference of appearance of the composite stringer 2 between the both sides of the boundary between the tape portion 3 and the fastening portion 4 would be reduced, owing to the same configuration of the tape portion 3 and the supporting portion 12 (this is similar to the above-described embodiments).

Again, the tape portion 3 and the supporting portion 12 may be collectively referred to as the fastener tape 56 in the present specification. The tape portion 3 is a main portion of the fastener tape 56. The supporting portion 12 is a side-edge portion of the fastener tape 56 (an opposing side-edge portion when the composite stringers 2 are arranged side-by-side). Further in some cases, the fastening elements 5 may not be integrated to the fastener tape 56 and/or the supporting portion 12, and a separate member attached thereto may be referred to as a fastener element 55. The fastener element 55 is supported by the fastener tape 56 and/or the supporting portion 12 which are separate to the fastener element 55.

In an embodiment illustrated in FIGS. 24 and 25, the fastening elements 5 are respective helical units of the fastener element 55 of a helical monofilament with engagement heads 53 formed at predetermined pitch. The fastener element 55 configured by the helical monofilament is sewn and secured to the supporting portion 12 by using machine-sewing thread. The machine-sewing thread is exposed on a side opposite to a side of the supporting portion 12 where the fastener element 55 is attached. The helical unit of the helical monofilament includes a first leg 50 extending in the width direction of the composite stringer 2, a second leg 52 extending in the width direction of the composite stringer 2, an engagement head 53 extending in the thickness direction of the composite stringer 2 to couple the first leg 50 and the second leg 52 and formed to be wider in width in the elongation direction of the composite stringer 2, and a return portion 54 that couples the first leg 50 and the second leg 52 between adjacent helical units. The first leg 50 is positioned in contact with the supporting portion 12, and the second leg 52 is positioned away from the supporting portion 12. The engagement head 53 is positioned away from the supporting portion 12 in the width direction of the composite stringer 2 and in contrast, the return portion 54 is positioned to overlap the supporting portion 12. Core thread may be inserted inside the helical monofilament but may be omitted.

With reference to FIGS. 25 to 27, configuration of the tape portion 3 would be further discussed. The tape portion 3 includes a first sheet portion 9a, 9c having resin-permeable structure, a second sheet portion 9b,9d having resin-permeable structure, and a resin 78 via which the first sheet portion 9a,9c and the second sheet portion 9b,9d overlap. The resin 78 permeates each structure of the first and second sheet portions 9a, 9c and 9b,9d, and the tape portion 3 has a surface condition of the first tape face 3a in accordance with the structure of the first sheet portion 9a,9c and has a surface condition of the second tape face 3b in accordance with the structure of the second sheet portion 9b,9d. A sheet member 9 is utilized to easily improve the surface conditions of the both top and bottom faces of the tape portion 3. Note that, the first and second sheet portions 9a,9c and 9b,9d are separate sheet members in some cases and in other cases, are separate portions of a same sheet member. Typically, the first and second tape faces 3a,3b have texture equivalent to texture of the first and second sheet portions and/or the resin 78 is not visible in the first and second tape faces 3a,3b for unaided vision (microscope-based observation required for its visualization).

The first sheet portion 9a,9c is a knitted fabric of a plurality of first knitting yarns 31. The plurality of first knitting yarns 31 may include chain stitch yarn, tricot yarn, satin yarn, weft-inserted yarn or any combination of these yarns, for example. In some cases, the first sheet portion 9a,9c has a warp knitted structure, and the plurality of first knitting yarns 31 includes at least plural chain stitch yarns (first chain stitch yarns) 95 and one or more weft-inserted yarns (first weft inserted yarns) 96. The chain stitch yarns 95 forms wales W1 to Wn of the first sheet portion 9a,9c respectively. In more detail, each chain stitch yarn 95 forms a series of loops R95 in the wale direction and forms sheet faces along the wale direction at the both of the first and second tape faces 3a and 3b. The total number of wales in the first sheet portion 9a, 9c is N and typically, N indicates a natural number in a range between 5 to 50. Normally, as the number of wales increases, the width W2 of the composite stringer 2 increases proportionally.

One or more weft-inserted yarn 96 swing to couple adjacent wales in the course direction as extending along the wale direction. The weft-inserted yarn 96 repeats to be interwoven to one wale Wp and to be interwoven to another wale Wq. The swinging width of the weft-inserted yarn 96 corresponds to subsets Wp to Wq of total wales in the first sheet portion 9a,9c and q-p may indicate a number equal to or less than ½ of N. The weft-inserted yarn 96 is interwoven to the chain stitch yarn 95 at the wale Wₚ and is interwoven to the chain stitch yarn 95 at the wale W_{q}. More preferably, when focusing on one wale, interweaving with one weft-inserted yarn 96 and interweaving with another weft-inserted yarn 96 are alternately formed, and the directions of these interwoven weft-inserted yarns 96 are opposite. As such, the wales are firmly coupled by the multiple of weft-inserted yarns 96. In cases where the first sheet portion 9a,9c includes plural weft-inserted yarns 96, the swinging width of each weft-inserted yarn 96 (number of wales straddled by it) is typically constant, but should not be limited to this. It would be possible to employ a weft-inserted yarn having a swinging width which varies along the wale direction.

The weft-inserted yarn 96 does not form a loop unlike the chain stitch yarn 95.

Therefore, the first tape face 3a is formed as a non-flat surface, and includes ribs 85 corresponding the wales W₁ to Wₙ and recesses 86 between the wales W₁ to Wₙ (schematically exaggerated in FIG. 25). The rib 85 is formed by needle loops, and the recess 86 is formed by weft-inserted yarns 96 or sinker loops bridging between the wales. As described above, the tape portion 3 includes the resin 78, and the resin 78 permeates the structure of the first sheet portion 9a,9c. As a result, the plurality of first knitting yarns 31 includes one or more first knitting yarns partially embedded in the resin 78. Furthermore, if the resin 78 permeates through the structure of the first sheet portion 9a, 9c, the plurality of first knitting yarns 31 includes one or more first knitting yarns partially covered by the resin 78 in the first tape face 3a. In this regard, in FIG. 25, the resin 78 reaches to the recess 86 to at least partially fill the recess 86, and a (typically flat) resin surface 78a of the resin 78 is formed between the ribs 85. The rib 85 is still not covered by the resin 78 and the first tape face 3a may impart a tactile sense of fibers. Accordingly, the first tape face 3a is preferably formed as the hybrid surface as discussed above, and waterproofness and desired texture are simultaneously obtained. Additionally to this, the unity of the first sheet portion 9a, 9c and the resin 78 is enhanced. Note that, the resin surface 78a is not necessarily a smooth surface. Moreover, the resin surface 78a may contain fine cracks due to thermal contraction of resin.

As understood from FIG. 27, the first tape face 3a includes exposed portions 951,961 of the first knitting yarn 31 exposed in the first tape face 3a, and the resin surfaces 78a of the resin 78 formed between the exposed portions 951,961. The resin surfaces 78a are formed between adjacent portions of the weft-inserted yarns 96 in the wale direction. The resin surfaces 78a may be formed between adjacent portions of the chain stitch yarns 95 in the course direction. Note that, the chain stitch yarn 95 and weft-inserted yarn 96 may be multifilament yarns. In this instance, respective filaments may be bonded via the resin 78.

The above description mainly focuses on the first sheet portion 9a, 9c and the first tape face 3a, but would equally apply to the second sheet portion 9b,9d and the second tape face 3b, thus overlapping description omitted. With respect to FIG. 27 by way of precaution, the second tape face 3b includes exposed portions 951′,961′ of the second knitting yarn 32 exposed in the second tape face 3b and a resin surface 78b of the resin 78b formed between the exposed portions 951′,961′. The second sheet portion 9b,9d is a knitted fabric including plural second chain stitch yarns 95′ forming plural wales W1 to Wn and one or more second weft-inserted yarns 96′ that swing in a width of two or more adjacent wales Wp to Wq included in the plural wales W1 to Wn.

The structure of the second sheet portion 9b,9d is not necessarily the same as the structure of the first sheet portion 9a,9c. Embodiment is envisaged where the first sheet portion 9a,9c is a knitted fabric and the second sheet portion 9b,9d is a woven fabric having plural warp threads and one weft thread as illustrated in FIG. 28. Of course, both of the first sheet portion 9a,9c and the second sheet portion 9b,9d may be woven fabrics. There are interstices between warp threads in the woven fabric, and there are also interstices between portions of the weft thread which extend in the weft direction. The molten resin can penetrate into and through these interstices. The warp threads may be partially covered by the resin. The same holds true to the weft thread. The woven fabric may have enlarged interstices by thinning out the warp threads.

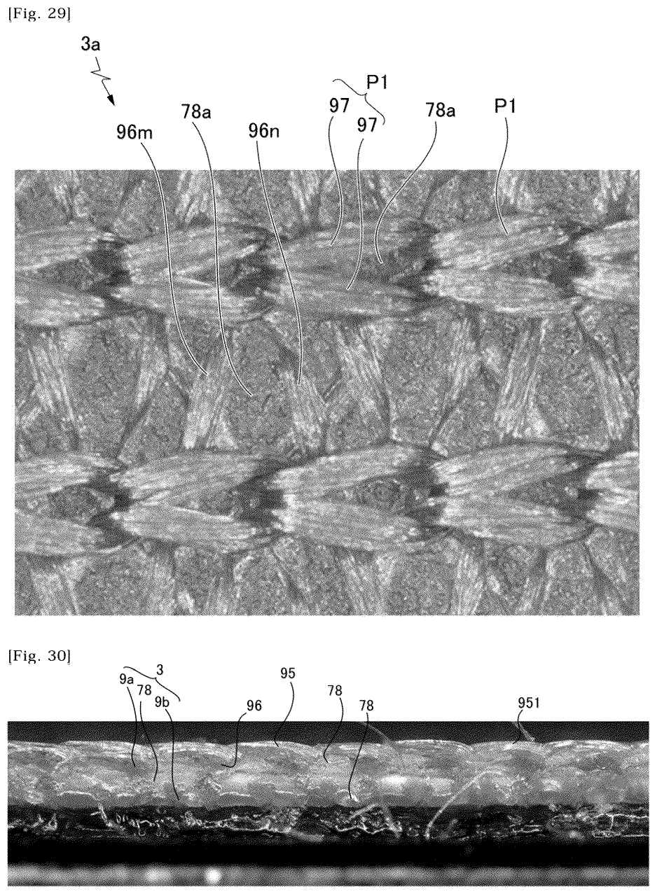

With reference to FIGS. 29 and 30, further description follows. Following the production method illustrated in FIG. 17, a tape portion 3 (i.e. fastener tape 56) was actually produced which has a structure schematically illustrated in FIG. 25. Knitted fabrics having knitted structure including chain stitch yarns and weft-inserted yarns were employed as the first and second sheet portions 9a, 9c and 9b,9d. Note that the fastening elements 5 were not integrated to the fastener tape 56 and/or to the supporting portion 12. Therefore, the first and second die wheels 10,20 were replaced by rolls having no mold cavity for fastening element. In view of this, the first and second die wheels 10,20 are referred to as first and second rolls 10′,20′ hereinafter.

Referring to FIG. 17, a resin 1 is supplied into a space between the first and second rolls 10′,20′ and sheet members 9,9′ are fed into the space between the first and second rolls 10′,20′ so as to interpose the resin 78. The resin 1 permeates the respective structures of the sheet member 9,9′ so that the tape portion 3 has a surface condition of the first tape face 3a in accordance with the sheet member 9 and has a surface condition of the second tape face 3b in accordance with the sheet member 9′. The space between the first roll 10′ and the second roll 20′ is situated directly beneath the discharging mouth of the extruder 90, and the sheet members 9,9′ are fed thereto. The resin 78 is in contact with the sheet member 9,9′ before its temperature falls largely through heat dissipation from the resin 78 via thermal contact with the air or with the first and second rolls 10′,20′, ensuring sufficient permeation of the resin 78 into and through the sheet member 9,9′.

It should be noted that the tape portion 3 according to the present disclosure may be produced based on a method other than the method disclosed in FIG. 17. For example, soft or molten resin 1 is supplied onto the circumferential surface of the first roll 10′ and a sheet member 9 having a resin-permeable structure is fed onto the circumferential surface of the first roll 10′ simultaneously as supplying the resin 1 onto the circumferential surface of the first roll 10′. If the sheet member 9 has sufficient thickness and recovering capability, it would be possible to form a resin layer inside the sheet member 9. Typically, two rolls 10′,20′ are used, but it would be possible to use one roll 10′ as shown in FIG. 18 for production. Other methods of production may be employed.

In FIG. 17, separate sheet members are fed corresponding to the first and second tape faces 3a and 3b of the tape portion 3 but this can be replaceable with separate portions of a same sheet, which is applicable to the entire descriptions of the present specification. This is straightforwardly described with reference to FIG. 34 (b) hereinafter.

As shown in FIG. 29, in the first tape face 3a, each chain stitch yarn 95 has a series of pairs P1 of raised portions (first raised portions) 97 raised from the resin surface 78a of the resin 78 permeating the structure of the first sheet portion 9a,9c. Multiple pairs P1 are arranged in the wale direction. The pair P1 of the raised portions 97 consists of two thread portions extending along the wale direction in one needle loop R95 formed by the chain stitch yarn 95. The first tape face 3a includes the resin surface 78a of the resin 78 between adjacent raised portions 97 (i.e. two thread portions) in the course direction. Similarly, the first tape face 3a includes the resin surface 78a of the resin 78 between the portions of the weft-inserted yarn 96 which extend in the course direction. In FIG. 29, the resin surface 78a is formed between different portions 96m,96n of the same weft-inserted yarn 96 but the resin surface is also formed between portions of different weft-inserted yarns 96.

In the first tape face 3a, the chain stitch yarn 95 has the raised portions raised higher than the weft-inserted yarn 96 and thus less likely covered by the resin 78 compared with the weft-inserted yarn 96, substantially or totally not covered in some cases. In contrast, the weft-inserted yarns 96 are more likely covered by the resin 78 compared with the chain stitch yarn 95. Typically, each weft-inserted yarn 96 is partially exposed and partially covered by the resin 78 in the first tape face 3a. The weft-inserted yarn 96 is partially covered by the resin 78, and thus the connection between the resin 78 and the first sheet portion 9a, 9c is strengthened, particularly resulting in anchoring effect that hinders peeling of the first sheet portion 9a,9c.

Surface conditions can be observed in the second tape face 3b similar to those shown in FIG. 29. By way of precaution again, in the second tape face 3b, each chain stitch yarn 95′ has a series of pairs P1′ of raised portions (second raised portions) 97′ raised from a resin surface 78b of the resin 78 permeating the structure of the second sheet portion 9b,9d. Other features would equally applicable.

As shown in FIG. 30, the resin 78 is formed as a layer between the first and second sheet portions 9a and 9b. If there are locations where the first knitting yarn 31 of the first sheet portion 9a and the second knitting yarn 32 of the second sheet portion 9b are in contact, the resin 78 would be discontinuous in the layer. In FIG. 30, such discontinuity is hardly observed. Also, in the same figure, it can be observed that the resin 78 penetrates through an interstice between the weft-inserted yarns 96 of the first sheet portion 9a. The same applies to the second sheet portion 9b.

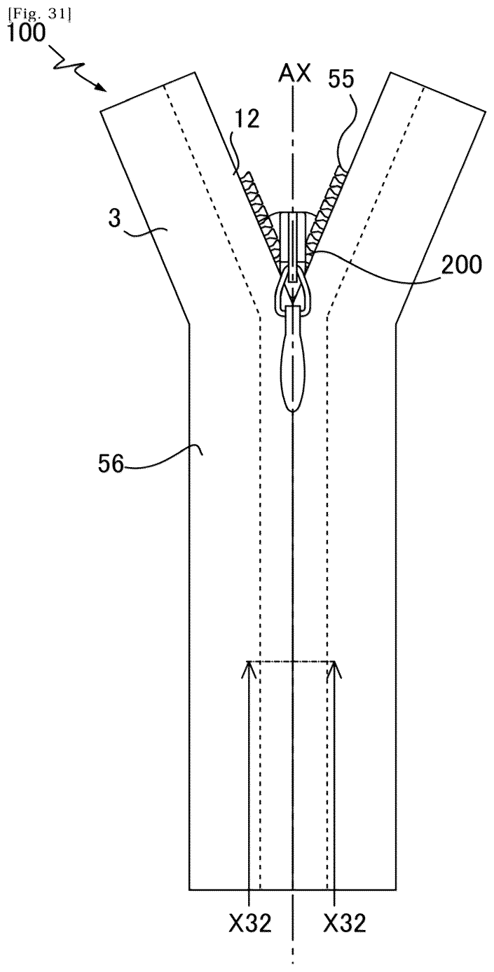

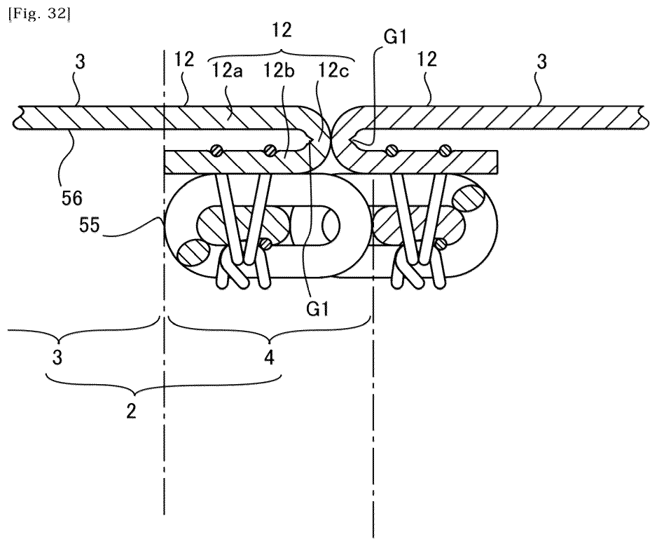

Referring to FIGS. 31 and 32, variations of the fastening device 100 would be discussed further. As illustrated in FIGS. 31 and 32, the fastening device 100 may be a so-called conceal slide fastener. The fastener tape 56 includes the tape portion 3 and the supporting portion 12. The supporting portion 12 includes a first portion 12a and a second portion 12b which are coupled via a bent portion 12c. The supporting portion 12 is folded at the bent portion 12c such that the first portion12a and the second portion 12b overlap in the up-down direction. The fastener element 55 is attached to the second portion 12b by machine-sewing thread(s). Machine-sewing thread(s) and needle eyelets formed through the second portion 12b (formed when the fastener element 55 is sewn by machine-sewing thread(s)) do not appear at the top side of the conceal slide fastener as being covered by the first portion 12a. The first portion12a is coupled to the tape portion 3 in a same layer. The first portion12a and the second portion 12b overlap, and a top plate of the slider 200 is inserted to a space therebetween. Configuration of the slider 200 is not illustrated, but would be one common for conceal slide fastener.

As the slider 200 moves forward to close the left and right composite stringers 2, the bent portion 12c of the fastener tape 56 of the left-side composite stringer 2 and the bent portion 12c of the fastener tape 56 of the right-side composite stringer 2 are brought into contact one another. This allows improved waterproofness of the fastening device 100. Slight space may be formed between the opposing bent portions 12c of the left and right composite stringers 2, but moisture penetration through the space is suppressed owing to fibers in the surface of the respective fastener tapes 56 (e.g. the above-described chain stitch yarns).

Similar to above, the fastener tape 56 includes the first sheet portion 9a,9c, the second sheet portion 9b,9d, and the resin 78 via which the both sheets overlap. In this instance, the softness of the tape would be lesser than the softness of a single layer knitted fabric or woven fabric. In this regards, a groove G1 may be formed in the bent portion 12c to allow the fastener tape 56 to sufficiently bend. The groove G1 may be continuously or intermittently formed along the elongation direction of the composite stringer 2. The groove G1 is formed in the curved surface of the bent portion that connects opposite surfaces of the first or second sheet.

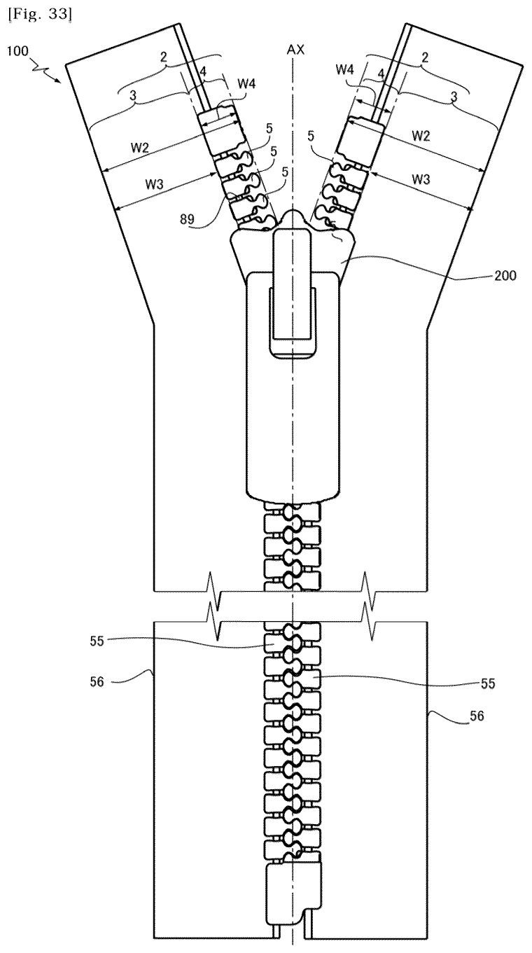

Referring to FIGS. 33 to 36, further variations are described. Unlike the above-described embodiments, the fastener tape 56 may have a tape core portion 89 in its side-edge portion. Moreover, it may be provided with fastener elements 55 which are resin-made or metal-made island portions. In cases where the fastener element 55 are made of resin, they are secured to the tape core portion 89 through injection molding. In cases where the fastener elements 55 are made of metal, they are secured thereto through swaging. In either embodiment, technical effects similar to those described above would be realized as long as the fastener tape 56 has features similar to those described above.

The resin-made or metal-made fastener elements 55 are arranged along the tape core portion 89 in one composite stringer 2 at constant pitch with interspaces therebetween. The same applies to the other composite stringer 2. Both composite stringers 2 are coupled such that the respective fastener elements 55 are alternately engaged. Each fastener element 55 has a base portion secured to the tape core portion 89, an engagement head positioned outwardly of fastener tape away from the tape core portion 89, and a neck coupling the base portion and the engagement head. The neck is narrower in width compared with the base portion and the engagement head.

Shape of aperture of extruder die can be designed as shown in FIG. 34(a). Accordingly, the resin 1 extruded from the extruder die would be the resin 78 (extruded product) having a cross section illustrated in FIG. 34(a). The extruded resin 78 with the core portion may be solidified, thus a burden of attaching a separate core portion to the resin 78 would be avoided. The resin 78 has a main portion 78m having a predetermined thickness and a core portion 78n having a thickness greater than the thickness of the main portion 78m. The main portion 78m has a first face 78p and a second face 78q. The core portion 78n is a portion having a substantially circular profile in cross section but other cross-sectional profile e.g. rectangular profile may be employed.

According to the method shown in FIG. 16, the sheet member 9 in sheath condition may be fed to the resin 78 extruded from the extruder. The sheet member 9 has sufficient flexibility to fold and bend, and is deformable into the sheath condition to enclose the resin 78. For example, the sheet member 9 may be in a sheath condition where the first and second sheet portions 9a,9b thereof are opposed with a predetermined interspace and are coupled via a curved portion 9n which is curved like “C”. The sheet member 9 in sheath condition is fed to the resin 78 so that the resin 78 is enclosed by the sheet member 9 precisely.

Similar to above, the first sheet portion 9a, the resin 78, the second portion 9b are pressed between the first roll 10′ and the second roll 20′. The resin 78 is at a high temperature as being discharged from the extruder die toward the interspace between the first roll 10′ and the second roll 20′ on the side of ground vertically. Therefore, the resin 78 can sufficiently permeate the respective structures of the first and second sheet portions 9a,9b of the sheet member 9 between the first roll 10′ and the second roll 20′. The core portion 78n of the resin 78 is covered by the C-like curved portion 9n and here again, the resin 78 permeates the structure of the sheet member 9. The resin 78 begins to solidify as being in thermal contact with the first and second rolls 10′,20′ and the air and heat dissipates thereto. At a time point where development of solidification is not sufficient yet, the resin 78 and the sheet member 9 are in contact and are pressed between the rolls. Accordingly, sufficient permeation of the resin 78 into and through the sheet member 9 is ensured.

Groove for receiving the core portion 78n of the resin 78 may be formed in each circumferential surface of the first roll 10′ and the second roll 20′. It would be possible to mold the core portion 78n and the tape core portion 89 in accordance with the opposed grooves in the respective circumferential surfaces of the first roll 10′ and the second roll 20′ without shaping the core portion 78n of the resin 78 in accordance with the shape of aperture of extruder die. Note that, as in the production method illustrated in FIG. 17, separate sheet members may be fed corresponding to both sides of the resin 78 extruded from the extruder. In this case, the side edges of the respective sheet members may be positioned side by side about the core portion 78n.

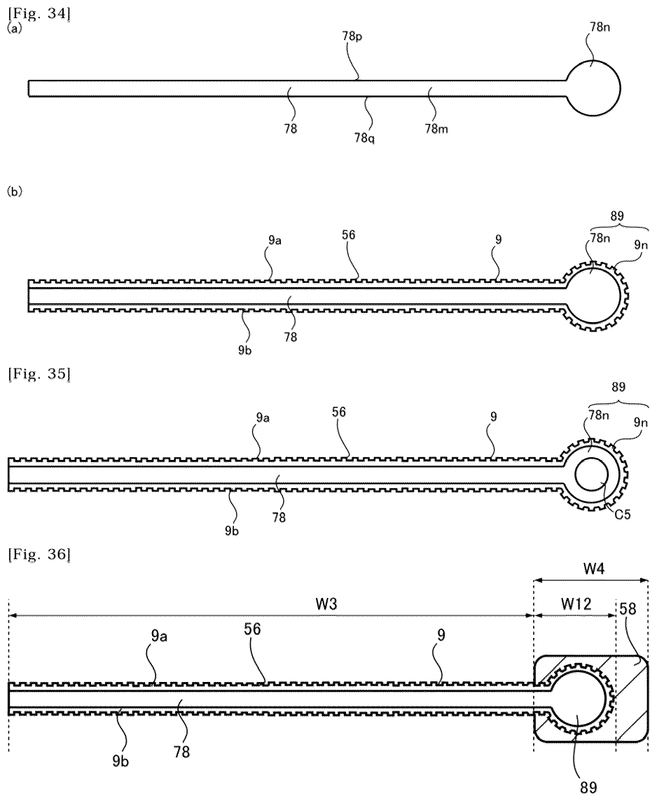

As illustrated in FIG. 35, a core thread C5 may be arranged in the core portion 78n of the resin 78. The core thread C5 may be continuously discharged together with the resin 1 through the extruder die. As such, the core thread C5 extending along the core portion 78n is embedded in the core portion 78n of the resin 78. Accordingly, the tape core portion 89 is reinforced by the core thread C5. The core thread C5 is preferably a knitted cord, and has sufficient stretch and higher adhesion to the core portion 78n. The resin 78 around the core thread C5 may permeates the core thread C5, and these may be bonded in strengthened manner.

As illustrated in FIG. 36, the fastener element 55 may be attached to the fastener tape 56 produced as described above. FIG. 36 depicts the resin-made fastener elements 55 attached to the tape core portion 89 through injection molding but should not be limited to this, and instead metal-made fastener elements may be swaged and attached to the tape core portion 89. The tape core portion 89 is formed in the fastener tape 56, thus ensuring sufficient attachment strength of the fastener elements thereto. As illustrated in FIG. 36, the composite stringer may be sectioned into the tape portion 3 and the fastening portion 4.

The present specification discloses embodiment of a composite stringer which is an integrated molded product of the tape portion 3 and the fastening portion 4 unlike embodiment where the fastener elements 55 are secured to the fastener tape 56. In particular, the following invention is also disclosed. According to the invention, with respect to a boundary between fastening portion and tape portion, the composite stringer is prevented from having different characteristic(s) (e.g. one or more characteristics selected from a group consisting of appearance, surface condition, softness and mechanical strength) between one and the other sides of the boundary.

### APPENDIX 1

A method of producing a composite stringer (2) including at least a tape portion (3) and a fastening portion (4), the method including:
supplying a soft or molten resin (1) onto a circumferential surface of a die wheel (10), the circumferential surface of the die wheel (10) including first and second molding belts (10a, 10b) adjacent in a width direction of the die wheel (10) and extending in a circumferential direction of the die wheel (10), the first molding belt (10a) being adapted to mold a fastening portion (4) including at least plural fastening elements (5), the second molding belt (10b) being adapted to mold or form the tape portion (3); and
feeding at least one sheet member (9) onto the circumferential surface of the die wheel (10) simultaneously as said supplying of the resin (1) onto the circumferential surface of die wheel (10), the sheet member (9) being fed onto the circumferential surface of the die wheel (10) so as to overlap at least partially the respective ones of the first and second molding belts (10a, 10b) and to cross a boundary between the first and second molding belts (10a, 10b) so that the composite stringer (2) has a surface condition or appearance in accordance with the sheet member (9) on both sides of the boundary between the tape portion (3) and the fastening portion (4).

### Appendix 2

The method of producing a composite stringer of Appendix 1 wherein the resin (1) and the sheet member (9) are supplied into an interspace between a pair of die

### APPENDIX 3

The method of producing a composite stringer of Appendix 2 wherein a circumferential surface of a second die wheel (20) of the pair of die wheels (10,20) includes a third molding belt (20c) adapted to mold the fastening portion (4) together with the first molding belt (10a) of the first die wheel (10).

### APPENDIX 4

The method of producing a composite stringer of Appendix 3 wherein the sheet member (9) is made of porous material allowing penetration or permeation of the resin (1) through the at least one sheet member (9), allowing the resin (1) to flow between the first molding belt (10a) and the third molding belt (20c).

### APPENDIX 5

The method of producing a composite stringer of any one of Appendixes 1 to 4 wherein the sheet member (9) has a width equal to or wider than a total width of the first and second molding belts (10a, 10b).

### APPENDIX 6

The method of producing a composite stringer of any one of Appendixes 1 to 5 wherein the resin (1) and the sheet member (9) are supplied onto the circumferential surface of the die wheel (10) so as to allow a structure of the sheet member (9) to be observable in one or both of top and bottom faces or a side face of the composite stringer (2).

### APPENDIX 7

The method of producing a composite stringer of any one of Appendixes 1 to 6 wherein the resin (1) and the sheet member (9) are supplied onto the circumferential surface of the die wheel (10) so that:
(i) a first region of the sheet member (9) is enclosed at least partially in a resin layer (78) of the tape portion (3), or a first region of the sheet member (9) is impregnated with a resin of the tape portion (3), or a first region of the sheet member (9) is laminated to a resin layer (78) of the tape portion (3); and
(ii) a second region of the sheet member (9) or a broken piece of the sheet member (9) is at least partially enclosed in a resin portion (79) of the fastening portion (4), or a second region of the sheet member (9) or a broken piece of the sheet member (9) is impregnated with a resin of the fastening portion (4), or a second region of the sheet member (9) or a broken piece of the sheet member (9) is laminated to a resin portion (79) of the fastening portion (4).

### APPENDIX 8

The method of producing a composite stringer of any one of Appendixes 1 to 7 wherein the composite stringer (2) has a pair of side-edge portions (71a,72a) extending along its elongation direction, and
the resin (1) and the sheet member (9) are supplied onto the circumferential surface of the die wheel (10) so as to allow at least one of the pair of side-edge portions (71a,72a) to have a surface condition or appearance in accordance with the sheet member (9).

### APPENDIX 9

The method of producing a composite stringer of any one of Appendixes 1 to 8 in which the circumferential surface of the die wheel (10) include a first belt including the first molding belt (10a) and the second molding belt (10b), and a second belt including a further first molding belt and a further second molding belt, the further first molding belt having a molding surface configured identical to the first molding belt (10a), the further second molding belt having a molding surface configured identical to the second molding belt (10b), the method further including:
separating a first composite stringer (2) molded in the first belt and a second composite stringer (2) molded in the second belt.

### APPENDIX 10

A composite stringer (2) comprising:
a tape portion (3); a fastening portion (4); and at least one sheet member (9), wherein each of the tape portion (3), the fastening portion (4) and the sheet member (9) extend in an elongation direction of the composite stringer (2), and the tape portion (3) and the fastening portion (4) are arranged adjacently, and wherein
the sheet member (9) is included in respective ones of the tape portion (3) and the fastening portion (4), and
the composite stringer (2) has a surface condition or appearance in accordance with the sheet member (9) on both sides of a boundary between the tape portion (3) and the fastening portion (4).

### APPENDIX 11

The composite stringer of Appendix 10 wherein a first region of the sheet member (9) is enclosed at least partially in a resin layer (78) of the tape portion (3), or a first region of the sheet member (9) is impregnated with a resin of the tape portion (3), or a first region of the sheet member (9) is laminated to a resin layer (78) of the tape portion (3).

### APPENDIX 12

The composite stringer of Appendix 10 or 11 wherein at least a part of a second region of the sheet member (9) or a broken piece of the sheet member (9) is enclosed in a resin portion (79) of the fastening portion (4), or a second region of the sheet member (9) or a broken piece of the sheet member (9) is impregnated with a resin of the fastening portion (4), or a second region of the sheet member (9) or a broken piece of the sheet member (9) is laminated to a resin portion (79) of the fastening portion (4).

### APPENDIX 13

The composite stringer of any one of Appendixes 10 to 12 wherein a part of the second region of the sheet member (9) is positioned in a side-edge portion of the fastening portion (4) distal to the tape portion (3).

### APPENDIX 14

The composite stringer of any one of Appendixes 10 to 13 wherein the fastening portion (4) encloses a part of the sheet member (9) or a broken piece of the sheet member (9); and/or a structure of the sheet member (9) is observable in one or both of top and bottom faces or a side face of the composite stringer (2).

### APPENDIX 15

The composite stringer of any one of Appendixes 10 to 14 wherein the fastening portion (4) includes a groove (7) extending in the elongation direction so as to form a box portion (41) on a side of one tape face of the tape portion (3), and a series of fastening elements (5) in which the fastening elements (5) are arranged on a bottom surface of the groove (7) along the elongation direction and gaps (6) are formed between adjacent fastening elements (5), each fastening element (5) including a stem (5a) standing on the bottom surface of the groove (7) along a thickness direction of the tape portion (3) and an engagement protrusion (5b) protruding from the stem (5a) in the elongation direction.

Based on the above teachings, a skilled person in the art would be able to add various modifications to the respective embodiments. Reference codes in Claims are just for reference and should not be referred for the purpose of narrowly construing the scope of claims. Boundary between the fastening portion and the tape portion encompasses both of a boundary line and a boundary area (e.g. another functional area).

### REFERENCE CODE

2: Composite stringer
3: Tape portion
3a: First tape face
3b: Second tape face
4: Fastening portion
5: Fastening element
56 Fastener tape
100: Fastening device
200: Slider

1. A fastening device comprising:
a pair of composite stringers; and
a slider, wherein each composite stringer of the pair of composite stringers includes a fastening portion and a tape portion that is wider than the fastening portion and has a thickness defined by first and second tape faces
the tape portion includes at least one sheet member and a resin that adheres to said at least one sheet member and is formed as a layer along said at least one sheet member, said at least one sheet member having a resin-permeable structure, the resin permeating the structure of said at least one sheet member and
the tape portion has surface conditions in accordance with the structure of said at least one sheet member in both of the first and second tape faces based on the permeation of the resin into the structure of said at least one sheet member

2. The fastening device of claim 1, wherein said at least one sheet member includes first and second sheet portions each having resin-permeable structure, the first and second sheet portions laminated via the resin
the resin permeates the respective structures of the first and second sheet portions to allow the tape portion to have a surface condition of the first tape face in accordance with the structure of the first sheet portion and to have a surface condition of the second tape face in accordance with the structure of the second sheet portion.

3. The fastening device of claim 2, wherein the first tape face is a hybrid surface of a resin surface of the resin and an exposed portion of the first sheet portion, the first sheet portion being partially covered by the resin and
the second tape face is a hybrid surface of a resin surface of the resin and an exposed portion of the second sheet portion the second sheet portion being partially covered by the resin.

4. The fastening device of claim 2, wherein the surface condition of the tape portion in at least one of the first and second tape faces imparts a tactile sense of fibers.

5. The fastening device of claim 4, wherein the first sheet portion is a woven or knitted fabric.

6. The fastening device of claim 5, wherein the first sheet portion is a knitted fabric including a plurality of first knitting yarns, and the first tape face includes exposed portions of the first knitting yarns exposed in the first tape face and resin surfaces of the resin each formed between the exposed portions.

7. The fastening device of claim 5, wherein the second sheet portion is a knitted fabric including a plurality of second knitting yarns, and the second tape face includes exposed portions of the second knitting yarns exposed in the second tape face and resin surfaces of the resin each formed between the exposed portions.

8. The fastening device of claim 2, wherein the first sheet portion is a knitted fabric including plural first chain stitch yarns forming plural wales and one or more first weft inserted yarns that swing in a width of two or more adjacent wales of the plural wales, and
each first chain stitch yarn of the plural first chain stitch yarns has a series of pairs of first raised portions which are raised from a resin surface of the resin permeating the structure of the first sheet portion.

9. The fastening device of claim 8, wherein the pair of the first raised portions is formed by two thread portions that extend in a wale direction in one needle loop of the first chain stitch yarn.

10. The fastening device of claim 9, wherein the first tape face includes the resin surface of the resin interposed between the two thread portions which are adjacent in a course direction.

11. The fastening device of claim 8, wherein said one or more first weft inserted yarns are partially exposed and are partially covered by the resin in the first tape face.

12. The fastening device of claim 8, wherein the first tape face includes the resin surface of the resin interposed between portions of the first weft inserted yarns extending in a course direction.

13. The fastening device of claim 8, wherein the second sheet portion is a knitted fabric including plural second chain stitch yarns forming plural wales and one or more second weft inserted yarns that swing in a width of two or more adjacent wales of the plural wales, and
each second chain stitch yarn of the plural second chain stitch yarns has a series of pairs of second raised portions which are raised from the resin surface of the resin permeating the structure of the second sheet portion.

14. A fastening device comprising:
a pair of composite stringers; and
a slider, wherein
each composite stringer of the pair of composite stringers includes a fastening portion and a tape portion that is wider than the fastening portion and has a thickness defined by first and second tape faces,
the tape portion includes first and second sheet portions each having a resin-permeable structure, and a resin via which the first and second sheet portions overlap,
the resin permeates the respective structures of the first and second sheet portions to allow the tape portion to have a surface condition of the first tape face in accordance with the structure of the first sheet portion and to have a surface condition of the second tape face in accordance with the structure of the second sheet portion.

15. The fastening device of claim 14, wherein the first tape face is a hybrid surface of a resin surface of the resin and an exposed portion of the first sheet portion, the first sheet portion being partially covered by the resin, and
the second tape face is a hybrid surface of a resin surface of the resin and an exposed portion of the second sheet portion, the second sheet portion being partially covered by the resin.

16. The fastening device of claim 1, wherein the fastening portion includes:
a groove that extends along an elongation direction so as to form a box portion at a side of the second tape face of the tape portion; and
an array of fastening elements in which the fastening elements are arranged on a bottom surface of the groove along the elongation direction and gaps are formed between adjacent fastening elements.

17. The fastening device of claim 1, wherein the fastening portion includes a fastener element, and a supporting portion that is separate to the fastener element and supports the fastener element,
the supporting portion is coupled to the tape portion in a same layer at least partially, the supporting portion including an extended portion of said at least one sheet member from the tape portion into the fastening portion and an extended portion of the resin from the tape portion into the fastening portion.

18. The fastening device of claim 17, wherein the supporting portion includes a first portion and a second portion which are coupled via a bent portion, the first portion coupled to the tape portion in a same layer,
the supporting portion is bent at the bent portion such that the first portion and the second portion overlap, and
the fastener element is secured to the second portion.

19. The fastening device of claim 18, wherein the bent portion is provided with a notch on its inner side which is formed continuously or intermittently along the elongation direction of the composite stringer.

20. (canceled)

21. (canceled)

22. (canceled)

23. (canceled)

24. (canceled)

25. A composite stringer comprising:
a waterproof fastener tape having a thickness defined by first and second tape faces; and
a fastener element attached to a side-edge portion of the fastener tape, wherein
the fastener tape includes first and second sheet portions each having a resin-permeable structure, and a resin via which the first and second sheet portions overlap,
the resin permeates the respective structures of the first and second sheet portions to allow the fastener tape to have a surface condition of the first tape face in accordance with the structure of the first sheet portion and to have a surface condition of the second tape face in accordance with the structure of the second sheet portion.

26. (canceled)

27. (canceled)
